(19) United States
(12) Patent Application Publication
(10) Pub. No.: US 2025/0371357 A1
(43) Pub. Date: Dec. 4, 2025

(54) AUTOMATED PLANNING DOMAIN DEFINITION LANGUAGE (PDDL) FILE GENERATION USING LARGE LANGUAGE MODELS

(71) Applicant: Royal Bank of Canada, Toronto (CA)

(72) Inventors: Yanshuai CAO, Toronto (CA); Raquel Yuri DA SILVEIRA AOKI, Coquitlam (CA); Keyi TANG, Vancouver (CA); Seyed Mohammad Sadegh MAHDAVI, Vancouver (CA)

(21) Appl. No.: 19/224,454

(22) Filed: May 30, 2025

Related U.S. Application Data
(60) Provisional application No. 63/654,354, filed on May 31, 2024.

(51) Int. Cl. G06N 3/0895

(52) U.S. Cl. CPC G06N 3/0895

(57) ABSTRACT

A method for translating natural language description of planning problems. A natural language description of the planning problem is used to generate problem candidates. Domain candidates are generated from the problem candidates. The domain candidates are refined using an evaluation metric. The problem and domain candidates can be problem planning domain definition language (PDDL) file. A planner can solve the planning problem using the output problem and domain candidates.

### CROSS-REFERENCE TO RELATED APPLICATIONS

This application claims priority to U.S. provisional patent application No. 63/654,354, filed on May 31, 2024, and entitled “Automated Planning Domain Definition Language (PDDL) File Generation Using Large Language Models”, the entirety of which is hereby incorporated by reference herein.

### FIELD OF THE DISCLOSURE

The present disclosure relates generally to large language models (LLMs), and in particular to automated planning domain definition language (PDDL) file generation using one or more LLMs, and systems, apparatuses, and non-transitory computer-readable storage media employing same.

### BACKGROUND

Large language models (LLMs) have been used in artificial intelligence (AI) for natural language processing such as language generation and text generation (such as generative AI). LLMs have shown remarkable performance in various natural language tasks. However, they often struggle with planning problems that require structured reasoning. To address this limitation, the conversion of planning problems into the planning domain definition language (PDDL) has been proposed as a viable solution, enabling the use of automated planners. However, generating accurate PDDL files typically demands human expertise and iterative refinement, which can be time-consuming and resource intensive.

### SUMMARY

Herein, embodiments of a planning domain definition language (PDDL) generation and planning method are disclosed.

In prior art LLMs, even small modifications to a PDDL domain can render plan search infeasible, highlighting the need for a more robust approach to domain/problem PDDL comparison. To address this problem, the Exploration Walk (EW) metric is introduced, which measures the similarity between two PDDL domains by comparing the executability of random action sequences sampled from one domain on the other. Experiments show that the EW metric provides a smooth measure of domain similarity that correlates well with the number of differing terms between two domains, making it a suitable objective for domain refinement.

The PDDL generation and planning method leverages LLMs to iteratively generate and refine PDDL domain and problem files without human intervention. More specifically, in at least some aspects, the PDDL generation and planning method first generates multiple problem PDDL candidates. Then for each problem, it iteratively generates domain PDDL candidates and selects the best one based on the EW metric computed using environment feedback (e.g., such as execution error messages or returned results). This enables progressive refinement of the domain without human intervention.

An example aspect of the PDDL generation and planning method is evaluated on 10 real-world PDDL environments. The evaluation results show that the PDDL generation and planning method disclosed herein outperforms a baseline that generates PDDL files in a single attempt without refinement. The PDDL generation and planning method solves seven (7) out of 10 environments, achieving an average task solve rate of 66% and average EW score of 0.84, compared to 34% task solve rate and 0.53 EW score for the baseline.

The PDDL generation and planning method enables modeling a planning environment via PDDL generation using LLMs and environment feedback, without the need for human intervention.

According to a first aspect, there is provided a method for iterative planning domain definition language (PDDL) file generation using at least one large language model (LLM), the method comprising: obtaining a natural language description of a domain defining possible predicates and actions for an environment, a domain PDDL template for the environment, a natural language description of a problem defining possible initial predicates and goal predicates for the environment, and a problem PDDL template for the environment; respectively generating at least one problem PDDL candidate as at least one response from the at least one LLM in response to inputting the natural language description of the problem and the problem PDDL template to the at least one LLM; iteratively generating a domain PDDL candidate by repeatedly performing a first iterative loop comprising: generating the domain PDDL candidate as a response from the at least one LLM in response to inputting the natural language description of the domain, the domain PDDL template to the at least one LLM, and any natural language feedback from a previous iteration for the domain PDDL candidate; evaluating the domain PDDL candidate against at least one of the at least one problem PDDL candidates; and in response to the evaluating, obtaining the natural language feedback from the environment for use in a subsequent iteration.

The first iterative loop may be performed a first predetermined number of times.

Evaluating the domain PDDL candidate against at least one of the at least one problem PDDL candidates may comprise performing an exploration walk of the domain PDDL candidate against the at least one of the at least one problem PDDL candidates.

The first iterative loop may comprise at least part of an inner iterative loop, a plurality of the domain PDDL candidates may be generated by repeatedly performing the inner iterative loop and an outer iterative loop, the outer iterative loop may comprise performing the inner iterative loop multiple times in order to generate a plurality of the domain PDDL candidates, and the method may further comprise: evaluating the plurality of generated domain PDDL candidates against the at least one of the at least one problem PDDL candidate; and in response to evaluating the plurality of generated domain PDDL candidates against the at least one problem PDDL candidate, returning one of the plurality of generated domain PDDL candidates.

The outer loop may be performed a second predetermined number of times.

Evaluating the plurality of generated domain PDDL candidates against the at least one of the at least one problem PDDL candidate may comprise performing an exploration walk of the plurality of generated domain PDDL candidates against the at least one of the at least one problem PDDL candidates.

Respectively generating at least one problem PDDL candidate may comprise respectively generating a plurality of problem PDDL candidates as a plurality of responses from the at least one LLM in response to inputting the natural language description of the problem and the problem PDDL template to the at least one LLM, and evaluating the plurality of generated domain PDDL candidates against the at least one problem PDDL candidates may comprise evaluating each of the generated domain PDDL candidates against each of the plurality of problem PDDL candidates.

Evaluating each of the generated domain PDDL candidates against each of the plurality of problem PDDL candidates may comprise performing an exploration walk with each of the generated domain PDDL candidates and each of the plurality of problem PDDL candidates.

The natural language feedback from the environment may comprise at least one execution error message or at least one returned result.

According to another aspect, there is provided a method of using at least one large language model (LLM) to generate computer-readable parameters for solving a natural language planning problem using a planner, the method comprising: obtaining a natural language description of a domain defining an environment of the planning problem, a natural language description of the planning problem defining a problem to be solved by the planning problem; generating at least one problem candidate defining a set of problem parameters for the planning problem as at least one response from the at least one LLM in response to inputting the natural language description of the planning problem and a problem candidate template for the set of problem parameters to the at least one LLM; for each one of the at least one problem candidate, iteratively generating a corresponding domain candidate defining a set of domain parameters for the environment by repeatedly performing an iterative loop comprising: generating a domain candidate as a response from the at least one LLM in response to inputting the natural language description of the domain and a domain candidate template for the set of domain parameters to the at least one LLM, and any natural language feedback from a previous iteration for the domain candidate; evaluating the domain candidate and the problem candidate; and in response to the evaluating, obtaining the natural language feedback from the environment for use in a subsequent iteration; and storing one of the at least one problem candidate the corresponding domain candidate based on the evaluating for execution by the planner.

The set of problem parameters may be generated as a problem planning domain definition language (PDDL) file; the set of domain parameters may be generated as a domain PDDL file; the problem candidate template may be a problem PDDL template; and the domain candidate template may be a domain PDDL template.

The set of problem parameters may define: one or more objects in the planning problem, initial conditions of the one or more objects, and goal conditions of the one or more objects.

The set of domain parameter may define: predicates of the environment and one or more actions, wherein each of the one or more actions is defined according to: one or more action parameters, one or more preconditions of the action, and one or more effects of the action.

The iterative loop may be performed a first predetermined number of times.

The evaluating of the domain candidate and the problem candidate may comprises determining an evaluation score; the evaluation score may be determined by evaluating a first metric determined by executing one or more legal actions from a set of legal actions on one or more objects in the problem candidate against a second metric determined by executing one or more actions from the domain candidate on one or more objects of a set legal objects; and the set of legal actions may correspond to the domain of problem and the set of legal objects corresponds to the problem of the planning problem.

The first and second metric may each correspond to a percentage of valid executions.

The evaluation score may be a similarity score corresponding to a harmonic mean of the first and second metric.

The first metric may be determined by executing a second predetermined number of consecutive one or more legal actions on the one or more objects in the problem candidate and the second metric may be determined by executing the second predetermined number of consecutive one or more actions on the one or more objects of the set legal objects.

The evaluation score may further comprise a negative modifier for one or more of: no possible action, invalid domain parameters, missing domain parameters, invalid domain modifications, and no domain modification.

The method may further comprise, for each iteration of the first iterative loop: generating a plurality of domain candidates, the evaluating may comprise, for each one of the plurality of domain candidates: evaluating the domain candidate and the problem candidate, and determining, based on the evaluating, one of the plurality of domain candidates for use in the subsequent iteration.

The plurality of domain candidates may be a third predetermined number.

The evaluating of the domain candidate against the problem candidate may comprise determining an evaluation score; wherein the evaluation score is determined by evaluating a first metric determined by executing one or more legal actions from a set of legal actions on one or more objects in the problem candidate against a second metric determined by executing one or more actions from the domain candidate on one or more objects of a set legal objects; and wherein the set of legal actions corresponds to the domain of problem and the set of legal objects corresponds to the problem of the planning problem.

The at least one problem candidate may be a fourth predetermined number of a plurality of problem candidates; and a plurality of corresponding domain candidates may be generated for the plurality of problem candidates.

The method may further comprise: evaluating the plurality of problem candidates and the plurality of corresponding domain candidates to determine the problem candidate and the corresponding domain candidate for the storing.

The problem candidate and the corresponding domain candidate for the storing may be determined using an evaluation score; the evaluation score may be determined by evaluating a first metric determined by executing one or more legal actions from a set of legal actions on one or more objects in the problem candidate against a second metric determined by executing one or more actions from the domain candidate on one or more objects of a set legal objects; and the set of legal actions may correspond to the domain of problem and the set of legal objects corresponds to the problem of the planning problem.

The method may further comprises: generating at least one domain proposal using the at least one LLM, wherein each of the at least one problem candidate is generated using one of the at least one domain proposal.

The domain candidate may be generated by using the at least one LLM to modify the domain candidate through an intermediate interface comprising predefined functions for modifying the domain candidate.

The method may further comprise: solving the planning problem by inputting the problem candidate and the corresponding domain candidate for the storing to the planner to generate a sequence of actions for solving the planning problem.

According to another aspect, there is provided a system comprising at least one processing structure configured to perform the above described method.

According to another aspect, there is provided at least one non-transitory computer readable medium having stored thereon computer program code that is executable by at least one processor and that, when executed by the at least one processor, causes the at least one processor to perform the above described method.

### BRIEF DESCRIPTION OF THE DRAWINGS

For a more complete understanding of the disclosure, reference is made to the following description and accompanying drawings, in which:

FIG. 1 is a schematic diagram of a computer network system for data sharing, according to some embodiments of the present disclosure;

FIG. 2 is a schematic diagram showing a simplified hardware structure of a computing device of the computer network system shown in FIG. 1;

FIG. 3 is a schematic diagram showing a simplified software architecture of a computing device of the computer network system shown in FIG. 1;

FIG. 4 is a plot showing effect of number of removed terms on plan search failure. Each gray line shows the PNFₖ (Plan-Not-Found) metric for one environment, according to some embodiments of this disclosure;

FIG. 5 is a plot showing correlation between average exploration walk (EW) score and average domain difference, according to some other embodiments of this disclosure, wherein the x-axis shows how may terms each pair of domains differ in, and the y-axis shows average EW score over various pairs, and all the domains show the monotonicity of EW score with respect to term difference;

FIGS. 6A and 6B are plots showing testing results for some example domains;

FIGS. 7A and 7B are schematic diagrams showing an example PDDL generation and planning method, according to some embodiments of this disclosure;

FIG. 8 is a method of translating a natural language planning problem into parameters for processing by a planner for solving the planning problem, according to some embodiments of this disclosure; and

FIGS. 9 to 21D show some dataset examples of files for various environments, wherein

FIG. 9 shows an annotated example domain, problem, and plan for an example Grippers environment;

FIG. 10 shows a Grippers domain PDDL;

FIG. 11 shows a Grippers problem PDDL;

FIGS. 12 and 13 show a Grippers problem natural language and a Grippers problem template PDDL, respectively;

FIGS. 14 and 15 show a Grippers domain natural language and a Grippers domain PDDL template, respectively;

FIG. 16 shows a Grippers problem plan;

FIG. 17 shows an incorrectly generated Grippers problem PDDL;

FIGS. 18A and 18B show a domain feedback from the Termes environment, where the LLM output refinement results in a correct domain;

FIGS. 19A to 19N show a domain back-translation prompt template, with domain PDDL and problem PDDL placeholders for each target domain;

FIGS. 20A to 20K show a domain back-translation prompt template, with domain natural language description and problem PDDL placeholders for each target domain; and

FIGS. 21A to 21D show a predicate translation python code generation prompt.

### DETAILED DESCRIPTION

Planning can be a crucial aspect of implementing artificial intelligence and involves finding a sequence of actions to achieve a desired goal state from an initial state. Planning Domain Definition Language (PDDL) is a widely used formalism for describing planning problems. PDDL provides a structured way to define the problem domain, which includes the types of objects, predicates, and actions, as well as the problem instance, which specifies the initial state and goal conditions. The advantage of using PDDL is that it enables the application of search-based algorithms, such as breadth-first search (BFS) and A*, which can guarantee finding a valid solution if one exists. However, the downside of PDDL is that it requires a well-defined and structured domain and problem definition, which can be challenging to create, especially for complex scenarios.

A planning problem refers to a scenario or problem that requires one or more events, in particular actions, to solve or complete. The domain refers to the world or environment of the scenario and can define the rules and setups of the world. In particular, the domain can define the objects in the world, what changes or actions can be applied or can alter the objects, as well as a set of rules for the world, objects, and actions. The problem, in particular the problem instance, refers to the scenario or problem itself. That is, it defines the objects involved in the problem, their initial conditions, and their final or goal conditions.

In accordance with one broad aspect of the present disclosure, automated systems and methods for generating PDDL domain and problem definitions by leveraging LLMs and environment feedback is provided. Generally, the present disclosure can enable one or more LLMs to establish a hypothetical or estimated environment corresponding to the domain, for example in the form of proposed PDDL domain descriptions. The LLMs can then verify and update the hypothetical environment by observing discrepancies between the feasibility of actions under the hypothetical environment and the real environment (e.g., ground-truth). Therefore, the present disclosure can enable LLMs to use classical planners to solve complex planning problems whose solutions may require hundreds or thousands of steps that all need to be correct.

As even small modifications to PDDL domains can render plan search infeasible, thereby limiting the feedback information for LLMs to perform in context update, the present disclosure provides a new metric for improving PDDL generation. The metric can be a smooth similarity measure between two domains determined by comparing the executability of random action sequences sampled from one domain on the other, in this case the hypothetical and real environments. Beneficially, the metric can be determined by accessing the action interface and checking the executability of the environments, without direct access to the ground-truth PDDL domain and problem. Further, the present disclosure can utilize a tree-search approach guided by the metric to leverage the LLMs to generate and refine the PDDL domain and problem files iteratively and automatically.

Prior art methods leverage LLMs to take domain PDDLs and problem PDDL specifications, and synthesize a Python™ function to generate domain-specific plans, as a replacement for search-based planning. Some prior art methods show that using LLMs to translate problem specifications to PDDL and using classical solvers result in a higher planning accuracy than using an LLM directly as a planner. Some prior art methods consider a similar setting, but assume that the list of objects is partially observable, and the LLM needs to interact with the world to observe the list of objects. While these methods can work to an extent, they all assume that domain PDDL files are already provided. Other prior art methods generate domain PDDLs from natural language and propose heuristics for comparing PDDL action domains. However, this approach assumes that predicates are provided, whereas the present disclosure makes no such assumption. These prior art methods rely on ground-truth problem instances for domain compatibility evaluation, whereas the present disclosure can directly translate problem PDDLs without any such assumptions. Additional prior art methods translate both domain and problem from natural language descriptions but are forced to rely on human experts to correct mistakes in the domain translation before generating problem PDDLs. That is, the present disclosure can translate both the problem and domain of the planning problem from natural language into the corresponding PDDL files without human intervention.

Prior art methods have also explored eliciting direct reasoning capabilities within LLMs. This reasoning can be either entirely direct or partially direct with the assistance of basic external tools. However, the primary limitation of these approaches lies in the inherent tendency of auto-regressive LLMs to produce errors in long horizon reasoning tasks. Even a minor mistake in a single reasoning step can lead to cascading errors, ultimately resulting in an incorrect final answer. When applied to planning problems, this approach delegates the entire plan generation process to an LLM instead of leveraging a dedicated classical planner, which can be suboptimal compared to generating PDDL code directly.

Additionally, prior art methods have also contemplated generating executable code from natural language instructions, in particular for SQL™ or Python™ code generation. For example, the LLM can act as a code translator, where the reasoning logic lies within the generated code. It was reasoned that LLMs are capable of Python™ code generation from docstrings to high accuracy and that taking multiple code samples from an LLM and picking the best samples can result in an accuracy boost. Other prior art methods show that iterative refinement of LLM responses improves the accuracy on the downstream tasks, especially given external feedback such as unit tests or human feedback. The present disclosure leverages LLMs to produce structured PDDL files. This task is challenging for prior art methods as there are two types of PDDL files, in contrast to a single Python™ script, and the two files need to be consistent with each other. Further, receiving external feedback and the evaluation of generated PDDL code is not as easy as Python™ unit tests, where errors are abundant and hard to trace. Additionally, LLMs are trained with a lot more Python™ code compared to PDDL, as the latter is much scarcer. However, the present disclosure can overcome these difficulties, as described herein.

PDDL files, namely the problem and domain PDDL files, are described herein as example outputs. These files can be processed by a planner, such as a classic planner running BFS, to determine a solution to the planning problem (e.g., as a series of actions), if one exists. Note that the output of the present disclosure is not limited to PDDL files and may be any suitable set of parameters that adequately captures the scope of the planning problem. In particular, the set of parameters can be a set of computer-readable parameters on which a planner can be executed. Note that the present disclosure can also be generally applicable for use with other types of planners or algorithms for solving the planning problem. Accordingly, the output from the present disclosure can correspond to or be adapted to the requirements of the planning problem solver.

Accordingly, the present disclosure can provide a number of technical effects. The disclosed systems and methods can transform a set of data inputs into a form which has a practical application. In particular, by processing a natural language description of the planning problem, the disclosed systems and methods can transform the natural language description into a set of computer-readable parameters by breaking down the problem itself into its basic elements (e.g., as PDDL files), which can be processed by a solver such as a classical planner to provide a solution to the problem. Planning problems are generally applicable for many tasks requiring a series of actions. In particular, planning problems may be useful in the field of automation and robotics, for example in controlling a robot to perform a series of actions based on a desired end result. Accordingly, the present disclosure can provide a straightforward method of providing instructions (e.g. to robots) from a natural language description of a problem through the use of a planner. For example, the instructions can be a series of actions determined by a planner (e.g., corresponding to the solution of the planning problem), which, if performed, can achieve the goal states defined in the planning problem.

Further, the disclosed systems and methods can provide a technical effect by outputting files (e.g., PDDL files) which were previously challenging or impossible to generate. Specifically, LLMs are not trained for long-horizon reasoning and are not adapted for PDDL file generation, which they have scarcely seen during training, if at all. Further, in order to provide the planner with parameters for solving the planning problem, two different types files may be required, namely the problem and domain PDDL files. Another added degree of difficulty lies in the fact that the two different files must correspond to each other and the description of planning problem. Therefore, previous methods were unable to generate both the problem and domain PDDL files from natural language, often being capable of only generating one or the other, and must do so with access to the full ground-truth data and/or through human intervention. Further, previous LLM-generated PDDL files are often invalid and cannot be processed by the planner for a successful solve. In contrast, the present disclosure can generate both valid problem and domain PDDL files directly from the natural language description of the planning problem without human intervention and access to the full ground-truth data.

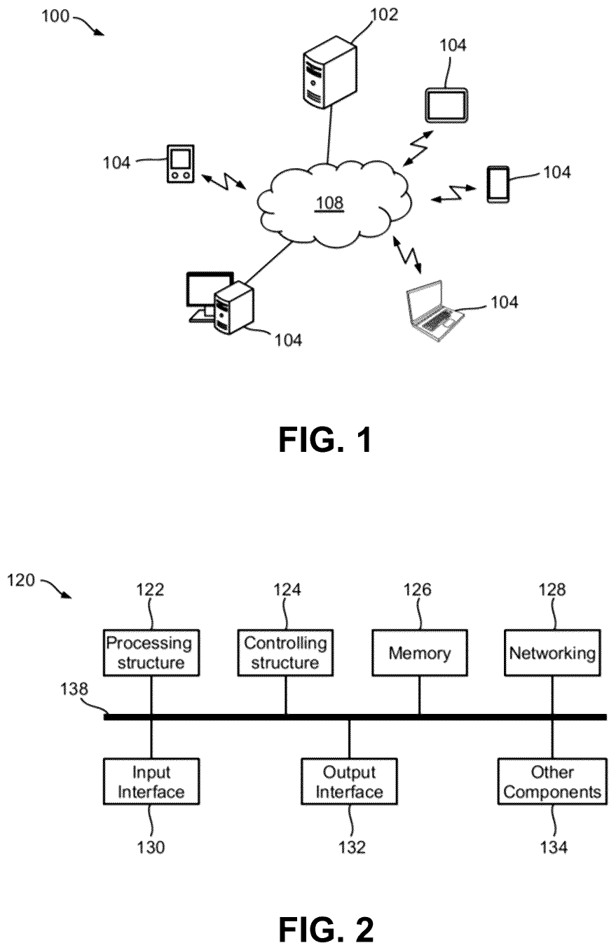

Turning now to FIG. 1, a computer network system is shown and is generally identified using reference numeral 100. As shown, the computer network system 100 comprises one or more server computers 102 and a plurality of computing devices 104 functionally interconnected by a network 108, such as the Internet, a wide area network (WAN), a metropolitan area network (MAN), a local area network (LAN), and/or the like, via suitable wired and/or wireless networking connections.

The server computers 102 may be computing devices designed specifically for use as a server, and/or general-purpose computing devices acting as server computers while also being used by various users. Each server computer 102 may execute one or more server programs.

The computing devices 104 may be portable and/or non-portable computing devices such as laptop computers, tablets, smartphones, Personal Digital Assistants (PDAs), desktop computers, and/or the like. Each computing device 104 may execute one or more application programs. In some embodiments, the computing devices 104 may comprise a server computer of another network system connected to the network system 100.

Generally, the computing devices 102 and 104 have a similar hardware structure such as a hardware structure shown in FIG. 2. As shown, the computing device 102/104 comprises a processing structure 122, a controlling structure 124, one or more non-transitory computer-readable memory or storage devices 126, a network interface 128, an input interface 130, and an output interface 132, functionally interconnected by a system bus 138. The computing device 102/104 may also comprise other components 134 coupled to the system bus 138.

The processing structure 122 may be one or more single-core or multiple-core computing processors such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, or the like. When the processing structure 122 comprises a plurality of processors, the processors thereof may collaborate via a specialized circuit such as a specialized bus or via the system bus 138.

The processing structure 122 may also comprise one or more real-time processors, programmable logic controllers (PLCs), microcontroller units (MCUs), μ-controllers (UCs), specialized/customized processors and/or controllers using, for example, field-programmable gate array (FPGA) or application-specific integrated circuit (ASIC) technologies, and/or the like.

Generally, each processor of the processing structure 122 comprises necessary circuitries implemented using technologies such as electrical and/or optical hardware components for executing one or more procedures as the implementation purpose and/or the use case maybe, to perform various tasks. In many embodiments, the one or more procedures may be implemented as firmware and/or software stored in the memory 126. Those skilled in the art will appreciate that, in these embodiments, the one or more processors of the processing structure 122, are usually of no use without meaningful firmware and/or software.

Of course, those skilled the art will appreciate that a processor may be implemented using other technologies such as analog technologies.

The controlling structure 124 comprises one or more controlling circuits, such as graphic controllers, input/output chipsets, and the like, for coordinating operations of various hardware components and modules of the computing device 102/104.

The memory 126 comprises one or more one or more non-transitory computer-readable storage devices or media accessible by the processing structure 122 and the controlling structure 124 for reading and/or storing computer-executable instructions for the processing structure 122 to execute, and for reading and/or storing data, including input data and data generated by the processing structure 122 and the controlling structure 124. The memory 126 maybe volatile and/or non-volatile, non-removable or removable memory such as RAM, ROM, EEPROM, solid-state memory, hard disks, CD, DVD, flash memory, or the like. In use, the memory 126 is generally divided into a plurality of portions for different use purposes. For example, a portion of the memory 126 (denoted as storage memory herein) may be used for long-term data storing, for example, for storing files or databases. Another portion of the memory 126 may be used as the system memory for storing data during processing (denoted as working memory herein).

The network interface 128 comprises one or more network modules for connecting to other computing devices or networks through the network 108 by using suitable wired and/or wireless communication technologies such as Ethernet, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, 5G New Radio (5G NR) and/or other 5G networks, 6G networks, and/or the like. In some embodiments, parallel ports, serial ports, USB connections, optical connections, or the like may also be used for connecting other computing devices or networks although they are usually considered as input/output interfaces for connecting input/output devices.

The input interface 130 comprises one or more input modules for one or more users to input data via, for example, touch-sensitive screens, touch-sensitive whiteboards, touch-pads, keyboards, computer nice, trackballs, microphones, scanners, cameras, and/or the like. The input interface 130 may be a physically integrated part of the computing device 102/104 (for example, the touch-pad of a laptop computer or the touch-sensitive screen of a tablet), or may be a device physically separated from but functionally coupled to, other components of the computing device 102/104 (for example, a computer mouse). The input interface 130, in some implementation, may be integrated with a display output to form a touch-sensitive screen or a touch-sensitive whiteboard.

The output interface 132 comprises one or more output modules for output data to a user. Examples of the output modules include displays (such as monitors, LCD displays, LED displays, projectors, and the like), speakers, printers, virtual reality (VR) headsets, augmented reality (AR) goggles, and/or the like. The output interface 132 may be a physically integrated part of the computing device 102/104 (for example, the display of a laptop computer or a tablet), or may be a device physically separate from but functionally coupled to other components of the computing device 102/104 (for example, the monitor of a desktop computer).

The computing device 102/104 may also comprise other components 134 such as one or more positioning modules, temperature sensors, barometers, inertial measurement units (IMUs), and/or the like. Examples of the positioning modules may be one or more global navigation satellite system (GNSS) components (for example, one or more components for operation with the Global Positioning System (GPS) of USA, Global'naya Navigatsionnaya Sputnikovaya Sistema (GLONASS) of Russia, the Galileo positioning system of the European Union, and/or the Beidou system of China).

The system bus 138 interconnects various components 122 to 134 enabling them to transmit and receive data and control signals to and from each other.

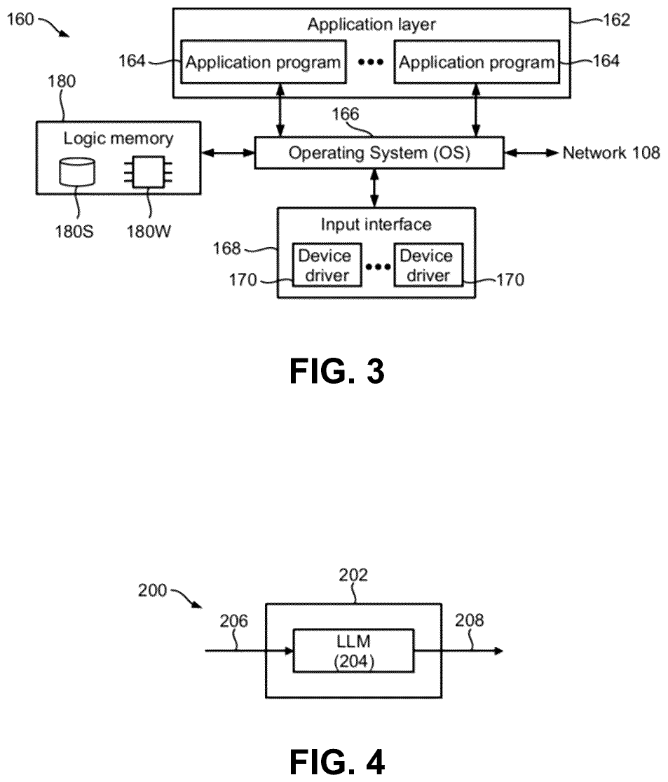

FIG. 3 shows a simplified software architecture of the computing device 102 or 104. The software architecture comprises an application layer 162, an operating system 166, a logical input/output (I/O) interface 168, and a logical memory 172. The application layer 162, operating system 166, and logical I/O interface 168 are generally implemented as computer-executable instructions or code in the form of software programs or firmware programs stored in the logical memory 172 which may be executed by the processing structure 122.

Herein, a software or firmware program is a set of computer-executable instructions or code stored in one or more non-transitory computer-readable storage devices or media such as the memory 126, and may be read and executed by the processing structure 122 and/or other suitable components of the computing device 102/104 for performing one or more procedures. Those skilled in the art will appreciate that a program may be implemented as either software or firmware, depending on the design purposes and requirements. Therefore, for ease of description, the terms “software” and “firmware” may be interchangeably used hereinafter.

Herein, a procedure has a general meaning equivalent to that of a method. More specifically, a procedure herein is a defined method implemented as software or firmware programs executable by hardware components for processing data (such as data received from users, other computing devices, other components of the computing device 102/104, and/or the like). A procedure may comprise or use one or more functions for processing data as designed. Herein, a function is a defined sub-procedure or sub-method for computing, calculating, or otherwise processing input data in a defined manner and generating or otherwise producing output data.

Alternatively, a procedure may be implemented as one or more hardware structures having necessary electrical and/or optical components, circuits, logic gates, integrated circuit (IC) chips, and/or the like.

Referring back to FIG. 3, the application layer 162 comprises one or more application programs 164 executed by or performed by the processing structure 122 for performing various tasks.

The operating system 166 manages various hardware components of the computing device 102 or 104 via the logical I/O interface 168, manages the logical memory 172, and manages and supports the application programs 164. The operating system 166 is also in communication with other computing devices (not shown) via the network 108 to allow the application programs 164 to communicate with programs running on other computing devices. As those skilled in the art will appreciate, the operating system 166 may be any suitable operating system such as MICROSOFT® WINDOWS® (MICROSOFT and WINDOWS are registered trademarks of the Microsoft Corp., Redmond, WA, USA), APPLE® OS X, APPLE® iOS (APPLE is a registered trademark of Apple Inc., Cupertino, CA, USA), Linux, ANDROID® (ANDROID is a registered trademark of Google Inc., Mountain View, CA, USA), or the like. The computing devices 102 and 104 of the computer network system 100 may all have the same operating system, or may have different operating systems.

The logical I/O interface 168 comprises one or more device drivers 170 for communicating with respective input and output interfaces 130 and 132 for receiving data therefrom and sending data thereto. Received data may be sent to the application layer 162 for being processed by one or more application programs 164. Data generated by the application programs 164 may be sent to the logical I/O interface 168 for outputting to various output devices (via the output interface 132).

The logical memory 172 is a logical mapping of the physical memory 126 for facilitating the application programs 164 to access. In this embodiment, the logical memory 172 comprises a storage memory area that may be mapped to a non-volatile physical memory such as hard disks, solid-state disks, flash drives, and/or the like, generally for long-term data storage therein. The logical memory 172 also comprises a working memory area that is generally mapped to high-speed, and in some implementations, volatile physical memory such as RAM, generally for application programs 164 to temporarily store data during program execution. For example, an application program 164 may load data from the storage memory area into the working memory area, and may store data generated during its execution into the working memory area. The application program 164 may also store some data into the storage memory area as required or in response to a user's command.

In a server computer 102, the application layer 162 generally comprises one or more server-side application programs 164 which provide(s) server functions for managing network communication with computing devices 104 and facilitating collaboration between the server computer 102 and the computing devices 104. Herein, the term “server” may refer to a server computer 102 from a hardware point of view, or to a logical server from a software point of view, depending on the context.

As described above, the processing structure 122 is usually of no use without meaningful firmware and/or software. Similarly, while a computer system 100 may have the potential to perform various tasks, it cannot perform any tasks and is of no use without meaningful firmware and/or software. As will be described in more detail later, the computer system 100 described herein, as a combination of hardware and software, generally produces tangible results tied to the physical world, wherein the tangible results such as those described herein may lead to improvements to the computer and system themselves.

In some embodiments, the computer network system 100 executes an artificial intelligence (AI) engine (for example, in the form of one or more software programs) for natural language processing such as language generation and text generation (such as generative AI). In particular and as shown in FIG. 4, the AI engine 202 comprises a large language model 204 (LLM; which is generally an artificial neural network) processing natural language input 206 (for example, in the form of text, voice, and/or the like), recognizing and interpreting the natural language input 206 for generating the output 208 in suitable forms.

In accordance with the present disclosure, the AI engine 202 uses a PDDL generation and planning method leveraging LLMs and environment feedback to automatically generate PDDL domain and problem files without the need for human intervention. In the context of environment feedback, the term “environment” refers to an environment external to the world/domain/problem being addressed by the computer system, and in particular refers to external sources, such as a program, a computer, a device, a system, another AI engine, and/or the like, interacting with the AI engine 202 and providing the AI engine 202 feedback regarding the output 208 thereof.

As will be described in more detail later, the PDDL generation and planning method disclosed herein introduces an iterative refinement process that generates multiple problem PDDL candidates and progressively refines the domain PDDL based on feedback obtained from the environment. To guide the refinement process, in some embodiments, an exploration walk (EW) metric is used to measure the similarity between PDDL domains by comparing the executability of random action sequences. The PDDL generation and planning method disclosed herein enables the automated modeling of planning environments using LLMs and environment feedback, thereby eliminating the need for human intervention in the PDDL generation process and leading to more efficient and scalable planning solutions. Evaluation of the PDDL generation and planning method disclosed herein on 10 real-world PDDL environments shows that the PDDL generation and planning method disclosed herein achieve an average task solve rate of 66% and an average EW score of 0.84, thereby demonstrating its effectiveness. In the context of the planning environment, the term “environment” refers to an internal, problem, or domain environment, for example corresponding to a world or scenario established by the planning problem.

In some embodiments, the PDDL generation and planning method disclosed herein generate structured PDDL files and thus is closely related to code generation.

However, the setting in the present disclosure possesses two challenges: (1) two types of PDDL files are generated, in contrast to a single python script, and the two files need to be consistent with each other; and (2) more importantly, getting external feedback and the evaluation of a generated PDDL code is not as easy as python unit tests, and as discussed further below, errors are abundant and hard to trace.

In the following, [⋅] denotes the indicator function. [N] denotes the set of positive integers {1, 2, . . . , N}. The notation 1:N refers to the sequence of integers ranging from 1 to N. For a set A, A* is defined as the set comprising all possible sequences of elements drawn from A, and 2^{A} is defined as the power set of A.

As those skilled in the art understand PDDL is a formal language used to describe and specify planning problems automated planning. In some embodiments, two types of PDDL files are used, namely, (1) domain PDDL, which defines possible predicates (that is, states), and actions in the environment, wherein executing each action requires some precondition (that is, a set of predicates to have a specific value), and the execution leads to some effect (that is, a change in the values of some predicates), (2) problem PDDL, which contains a set of initial predicates and a set of goal predicates.

Referring first to the domain of the planning problem, it can define a set of predicates and actions. Predicates refer to rules that objects and actions within the environment must follow, including properties and relationships between objects. Actions can be defined through an action interface, which includes the parameters, preconditions, and effects of the actions. In particular, a precondition can define a set of parameters that must be true for an action to occur and an effect can define a set of parameters that the action results in (e.g., how the world and object(s) defined in the domain changes). Further, a parameter of an action can define variables (such as an object) in the domain that the action acts on or changes. For example, for a move action, the parameters can be the object that is being moved, a starting point of the object, and an ending point of the object. The preconditions can be that the object is at the starting point and the effect can be that the object is at the ending point and not in the starting point.

Now referring to the domain of the planning problem, it can define the objects (e.g., provide a list of objects), the initial states of the objects (initial predicates), and the goal conditions/states (goal predicates) of the objects, where the goal conditions refer to the desired result of the planning problem.

For the planner to process the planning problem, the domain and problem of the planning problem must be translated from natural language into sets of parameters that can be interpreted by the planner. By processing the domain and the problem, the planner can “solver” the planning problem, that is, find a series of actions which will transition the initial states into the goal states.

The problem PDDL instantiates the domain definition PDDL to form a concrete environment. Together, the planning problem is fully defined and formalized. A classical planner takes in both files, and searches for a plan based on the provided specification. A plan is a set of consecutive actions, which starting from the initial state, leads to a state satisfying the goal conditions, with each action respecting the rules of the environment. Formally, let D, P, A be the set of all possible domains, problems, and actions, respectively. Then, given a domain d∈D and problem p∈P, a classical planner C:D×P→A*∪{⊥}, where ⊥ represents a planning error, takes in domain d and plan p, and produces a plan q:=C(d, p) which is either a set of actions from A*, or a planning error ⊥. A planning error may be due to infeasible plan search (that is, plan not found), syntax errors, or incompatible domain and problem. A plan validator, denoted as V_{d, p}:A*→{0, 1} verifies whether a plan q is executable and achieves the desired problem goal given a domain PDDL d and a problem PDDL p. The output of the validator is one (1) if the plan is valid, and is zero (0) otherwise. For computational convenience, it is assumed that V_{d, p} (⊥)=0. Similarly, a plan execution checker E_{d,p}:A*→{0, 1} is defined, which only checks whether or not an action sequence is executable in a domain. Note that the difference between E and V is that E only checks for plan executability, and V checks for both executability and goal satisfaction. S is defined as the set of all possible states. Function A_{d, p}: S→2^{A} delineates the set of possible permissible actions given the current states, and function S_{d,p}:A×S→S is the state transition function (that is, S_{d, p} (a, s) determines the subsequent state given the current state s and action a). The initial state induced by d and p is defined as s_{d,p,0}∈S.

Herein, LLMₙ (X) denotes sampling n responses from the LLM given prompt X. Often, the LLM takes constant prompts such as instructions, or in-context examples, which may be implicitly provided and may not be part of X. In some embodiments, a temperature of τ=0 is used for sampling with n=1 (that is, greedy sampling), and a temperature of τ=0.7 for n>1. Whenever possible, zero-shot chain-of-thought prompts described in academic paper entitled “Large language models are zero-shot reasoners,” to T. Kojima, S. S. Gu, M. Reid, Y. Matsuo, and Y. Iwasawa, published in Advances in Neural Information Processing Systems, volume 35, pages 22199-22213, 2022, the content of which is incorporated herein by reference in its entirety, may be used for the LLM to reason before generating a solution.

The summary of notations is provided below in Table 1.

TABLE 1
Summary of notations and definitions

| Notation | Description |
|---|---|
| 1: N | Sequence of integers ranging from 1 to N |
| [symbol] * | Set comprising all possible sequences of elements drawn from |
| | set [symbol] |
| [symbol] | Power set of [symbol] |
| [symbol] | Set of all possible domains in PDDL |
| [symbol] | Set of all possible problems in PDDL |
| [symbol] | Set of all possible actions in PDDL |
| ⊥ | Planning error |
| C: [symbol] × [symbol] → [symbol] * ∪ {⊥} | Classical planner function that takes a domain d ∈ [symbol] and a |
| | problem p ∈ [symbol] and produces a plan q |
| V_{d, p}(q): [symbol] * → {0, 1} | Plan validator function for domain d and problem p, returns 1 if |
| | plan q is valid, otherwise 0 |
| E_{d, p}: [symbol] * → {0, 1} | Plan execution checker for domain d and problem p, returns 1 if |
| | action sequence is executable, otherwise 0 |
| [symbol] | Set of all possible states |
| A_{d, p}: [symbol] → [symbol] | Function delineating the set of legal actions given the current |
| | state for domain d and problem p |
| S_{d, p}: [symbol] × [symbol] → [symbol] | State transition function, determines the next state given the |
| | current state and action in domain d and problem p |
| s_{d, p, 0} | Initial state induced by domain d and problem p |
| LLMₙ(X) | Sampling n responses from the LLM given prompt X |

The PDDL generation and planning method is now described.

Given an environment e and its domain natural language description, a task problem natural language description, and environment action interface, the PDDL generation and planning method models the environment by generating a domain PDDL \hat{d}∈D and a problem PDDL \hat{p}∈P, such that applying a classical planner C on the PDDL files produces a valid plan for the downstream task on the environment e, that is, C(\hat{d}, \hat{p}) is a valid plan for e, (e.g., C(\hat{d}, \hat{p})=1). An action interface can be used to define an action in the context of the domain. In particular, the action interface can comprise four aspects: the name of an action that can be taken, the parameters of the action corresponding to the objects or variables the action operates on (e.g., what performing the action does), the preconditions of the action, and the effects of the action.

To facilitate evaluation, there exists a ground truth domain PDDL d∈D, and a corresponding problem instance p∈P, which enables the validation of the plan \hat{q}:=C(\hat{d}, \hat{p}) by evaluating it on the validator of the ground-truth environment V_{d,p}(\hat{q}). Formally, for each environment e with domain PDDL d∈D, and N tasks with their corresponding ground-truth problem PDDLs p_{1:N}:=(\hat{p}₁, \hat{p}₂, . . . , \hat{p}_{N}), p_{1:N}∈P^{N}, the PDDL generation and planning method generates a domain PDDL \hat{p}, and a sequence of task PDDLs p_{1:N} (\hat{p}₁, \hat{p}₂, . . . , \hat{p}_{N}) such that the utility function U is maximized:

$${arg max}_{\hat{d} ∈ 𝒫 , {\hat{p}}_{1 : N} ∈ {𝒫}^{N}} U ( \hat{d} , {\hat{p}}_{1 : N} ; d , {p}_{1 : N} ) := \frac{1}{N} {\sum }_{i = 1}^{N} {V}_{d , {p}_{i}} ( C ( \hat{d} , {\hat{p}}_{i} ) ) . \qquad ( 1 )$$

Here, the ground truth PDDLs remain inaccessible for the generation of \hat{d} and \hat{p}_{1:N}, being solely reserved for the evaluation process. That is, portions of the ground-truth PDDLs may be used for evaluating the PDDLs generated by the LLM, as described further herein.

Generating accurate \hat{d} and \hat{p}_{1:N} in one attempt is often impractical, and some form of feedback is required to refine the response. In prior art, methods leveraging human expert feedback on \hat{d} to correct the generated domain are used. However, human feedback has its own disadvantages such as reliability and scalability, instead, to the present disclosure can rely on environment feedback for such corrections.

The following assumptions are made in respect of the present disclosure:

Assumption (1) (Environment): It is assumed that the list of objects and action interfaces are known. That is, at each state, the actionable actions are retrievable from the environment. Furthermore, access is assumed to executability and verifiability of actions (i.e., the functions V_{d,p} and E_{d,p}), as well as a natural language description of each state at each step. Such access does not require the underlying environment to be a PDDL environment, but it can be any environment with such provided interfaces. For example, for each world/environment defined by a set of PDDLs (problem and domain), one can verify actions defined by the set of PDDLs to determine if they are legal (can be executed or would result in a valid state) or illegal (cannot be executed or would result in an execution error/invalid state).

Assumption (2) (Problem): For a task, it is assumed a natural language description of the task (e.g., the problem of the planning problem) is given. In some embodiments, it is also assumed that a problem PDDL template with the list of objects, and empty initial and empty goal states are given for the problem.

Assumption (3) (Domain): For each domain, it is assumed a natural language description of the domain. within some embodiments, it is also assumed that a domain template PDDL including action interfaces, are given. The template can contain an empty predicate list, and an empty action interface including an empty list of preconditions and effects for each action.

The action interfaces can be considered equivalent to application programming interfaces (APIs) available to LLM agents. So it can be reasonable to assume that the exact API call signatures are known. On the other hand, the object list is assumed to be given because the natural language description may not refer to the object instances using the same label as the environment induced by d and p. If p refers to a robot as robot1 but the user specifying the natural language problem description calls it Jarvis, then the environment only recognizes robot1 and not Jarvis, so the LLM would have no way to correct this mistake due to a trivial name mismatch.

Note that the assumptions do not require the underlying environment to be a PDDL environment, and can instead be any environment as long as the set of parameters as generated by the LLM (e.g., PDDLs) is expressive enough to capture the working mechanisms of the environment. For digital agents in virtual environments, the list of objects and action interfaces are just different data objects and APIs available. The assumptions may in at least some embodiments hold true for physical agents in the real world, provided recognition and control are sufficiently accurate.

In some embodiments, the PDDL generation and planning method lifts the assumption that a human is available to make corrections on the proposed environment. Rather, the PDDL generation and planning method relies on getting feedback from the environment to refine the proposed domain. However, getting feedback from the environment to refine the generated domain \hat{p}, and problem \hat{p} may not be straightforward. For instance, one approach is to find a plan \hat{q}:=C(\hat{d}, \hat{p}), and run it through the real environment to get feedback. However, it can be shown that in many scenarios the slightest divergence of \hat{d} from d results in plan search failure, that is, \hat{q}=⊥.

To demonstrate the impact of small modifications to the domain d, synthetic domain instances are generated by randomly omitting k terms, where 0≤k≤10, from the action precondition and effects of the original domain d. Namely, \hat{d}ₖ˜ₖ(d) is defined, where ₖ(d) represents the uniform random removal of k terms. Then, for each generated \hat{d}ₖ, the PDDL generation and planning method computes whether the classical planner is able to find a plan without error, and get the following Plan-Not-Found (PNF) metric for the environment:

$${PNF}_{k} ( d , {p}_{1 : N} ) := {𝔼}_{{\hat{d}}_{k} ∼ {ℙ}_{k} ( d )} [ \frac{1}{N} {\sum }_{i = 1}^{N} [ C ( {\hat{d}}_{k} , {p}_{i} ) = ⊥ ] ] .$$

The PNFₖ can be used as a metric to measure how brittle the plan searching is with respect to different terms in the domain, wherein more critical terms lead to higher PNFₖ.

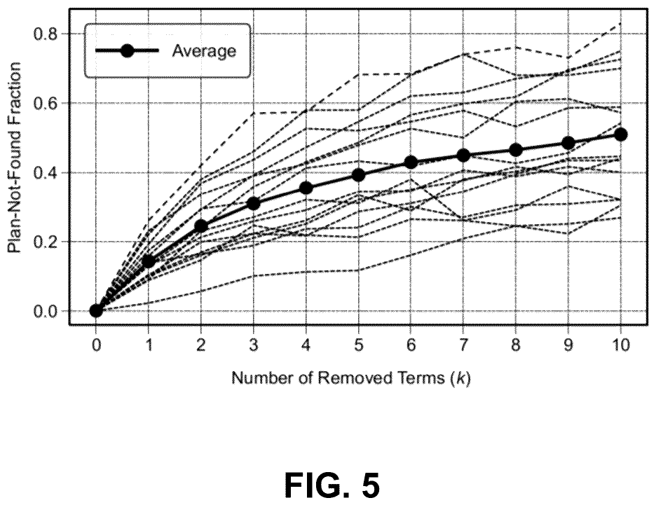

FIG. 5 is a plot showing the effect of number of removed terms on plan search failure, obtained by empirically measuring the value of PNFₖ using Monte-Carlo estimation on 12 environments, wherein each thin line shows the PNFₖ (Plan-Not-Found) metric for one environment, and the red line is the average over all environments.

As shown in FIG. 5, PNF₁ has an average of 0.14 among different environments, which means that on average 14% of the terms in domain PDDLs are so critical that removing them results into a plan-not-found error. This situation is exacerbated by larger values of k, for instance, at k=3, and the average PNFₖ reaches around 0.3. Note that this scenario assumes access to the ground-truth problem PDDL \hat{p}ᵢ. Moreover, the terms in \hat{d}ₖ are a subset of terms in d. However, in practice, the problem PDDL \hat{p}ᵢ needs to be generated, and the generated domain \hat{d} may have extra terms, both of which may further increase the planning-not-found rate.

In some embodiments, an exploration walk (EW) may be used as a metric to measure domain discrepancy. Directly running a classical planner on a generated \hat{d} and \hat{p} may fail even in the plan search phase. Thus, in some embodiments, the PDDL generation and planning method uses an alternative metric to compare two domains. As described herein, EW can be used to determine/calculate an evaluation metric or score (EW score) for evaluating how accurate the generated PDDLs are. For example, EW can reflect how likely it is that the generated PDDLs correspond to the ground-truth PDDLs; that is, how likely the generated PDDLs are valid and can therefore be used to solve the planning problem. The execution of the EW and the metric determined therefrom may be used interchangeably herein.

Whenever the plan search by a planner fails, no information is available to the LLM about which part of the problem or domain has issues. This is because the underlying search algorithm (such as BFS and A*) fails and as a result, it does not produce any (meaningful) output. For example, BFS enumerates all paths (possibly several thousand paths or more), and may find none satisfy the goal conditions, leaving the plan search without any useful insights. EW can therefore address the missing feedback as a smooth feedback signal that provides incremental feedback for LLM in-context learning. EW can both provide a mechanism to gather richer feedback information that feeds into LLM context for PDDL refinement, as well as compute a smooth scoring evaluation metric that compares multiple PDDLs and guides the refinement process forward.

Broadly, EW can be performed by taking legal random action sequences and verifying their executability under LLM's “mental model” environment induced by an LLM-generated PDDL domain. This is analogous to the retrodiction step in scientific methodology, where existing observations and experimental data need to be explained by the existing model. And in the other direction, EW takes executable random action sequences from an LLM-generated PDDL domain and verifies whether they are correct in the real environment. This is analogous to hypothesis testing in scientific methodology, where new predictions are verified experimentally.

Definition 1 (EW): Suppose domain PDDL d∈D, problem PDDL p EP, and non-negative integer T. Define the probability distribution _{d,p,T} over all possible T-step action sequences in A* with the following probability density function for each T-step plan q_{1:T}:=(q₁, q₂, . . . , q_{T})∈A* with s_{d,p,t}:=S_{d,p}(qₜ,s_{d,p,t-1}) for t∈[T]:

$${ℙ}_{d , p} ( {q}_{1 : T} ) := \{ \begin{matrix}0 & if {E}_{d , p} ( {q}_{1 : T} ) = 0 \\ {\prod }_{t = 1}^{T} \frac{1}{\vert A ( {q}_{t} \vert {s}_{d , p , t - 1} ) \vert} & otherwise\end{matrix} .$$

Then, _{d,p,T} is defined as the strictly positive T-step exploration walk distribution ford, p, and any q˜_{d,p,T} as a T-step exploration walk, where T is the length of the EW.

In the exploration walk distribution, at each step, the probability of selecting any applicable action is uniformly distributed among all applicable actions in the current state. Note that if there exists no valid T-step action sequence, the probability distribution _{d,p,T} is ill-defined. That is, the probability of non-executable action sequences is assumed to be zero under _{d,p,T}. In other words: ∀q_{1:T}, [symbol] _{d,p,T}(q_{1:T})>0 iff E_{d,p}(q_{1:T})=1.

As an example, the simplest possible EW may be used, with a uniform distribution over valid actions at each step. Note that to sample uniform random EW from the ground-truth environment induced by d and p, there is no need to access the full ground-truth data (e.g., d and p). In particular, only the list of objects in p and the action interface in d, and executability checker E_{d,p}, may be required. That is, at each step, it is possible to run the executability checker on all possible actions and yield the legal actions at that step for EW. Note that the executability check may be implemented as any suitable algorithm or program known in the art that can process the set of parameters as defined in the generated problem and domain.

In some embodiments, the evaluation metric or score based on EW can be an effective smooth metric to find domain differences. Specifically, define the measure m_{d→\hat{d}}(p_{1:N}, p_{1:N}) for computing the alignment between two domains d and \hat{d} as follows:

$${m}_{d \to \hat{d}} ( {p}_{1 : N} , {\hat{p}}_{1 : N} ) := \frac{1}{{N}^{2} {T}_{max}} {\sum }_{i = 1}^{N} {\sum }_{j = 1}^{N} {\sum }_{T = 1}^{{T}_{max}} {𝔼}_{q ∼ {ℙ}_{d , {p}_{j} , T}} [ {E}_{\hat{d} , {\hat{p}}_{j}} ( q ) ] \qquad ( 2 )$$

$${m}_{d ↔ \hat{d}} ( {p}_{1 : N} , {\hat{p}}_{1 : N} ) := \frac{2}{1 / {m}_{d \to \hat{d}} ( {p}_{1 : N} , {\hat{p}}_{1 : N} ) + 1 / {m}_{\hat{d} \to d} ( {\hat{p}}_{1 : N} , {p}_{1 : N} )} ,$$

where Tₘₐₓ is the largest EW walk length. The m_{d→\hat{d}} measures what fraction of exploration walks sampled from domain d are executable on the domain \hat{d}. Then, m_{d→\hat{d}} takes the harmonic mean of m_{d→\hat{d}} and m_{\hat{d}→d} to produce the final exploration walk measure. Note that p_{1:N} and \hat{p}_{1:N} are the problems in the domains d and \hat{d}, respectively. This metric has two favorable properties:
(1) Symmetry: it ensures that [symbol] = [symbol] , thereby providing a consistent measure of similarity regardless of the order of domain comparison;
(2) The harmonic mean is resistant to trivial domain similarity inflation: by employing the harmonic mean rather than the arithmetic mean, the metric used herein prevents domains that are overly permissive (for example, domains where all actions are permissible without any preconditions) from being deemed highly similar to more restrictive domains. For example, in a scenario where domain \hat{d} allows all possible actions without restrictions, m_{d→\hat{d}} may equal to one (1). An arithmetic mean in this context may yield [symbol] ≥0.5, overestimating the similarity. In contrast, the harmonic mean results into [symbol] =∈, where (∈<<1) for most trivial cases.

Note that while the PDDL problems p_{1:N} and \hat{p}_{1:N} appear in the definition of EW scores, they are utilized because there are aligned object sets in them. Alternatively, other embodiments can also use an arbitrarily sampled object list to form an P and pair \hat{P} with D and \hat{D} for performing EW calculations. For the purpose of PDDL generation, \hat{p}_{1:N} are already being generated, as described herein, and as such, it can be more convenient to use \hat{p}_{1:N}.

More generally, EW can be executed given a set of parameters generated by the LLM and a set of parameters defining legal actions and objects. In particular, the set of parameters generated by the LLM can be determined from/using the problem and domain PDDL files. The generated set of parameters can comprise a set of objects in the environment, for example extracted from the problem PDDL, and a set of actions can be legally performed in the environment (determined by the LLM), for example extracted from the domain PDDL (e.g., the action interface). These sets of parameters can capture the LLM's view of the environment within the planning problem and the rules thereof. The set of parameters defining legal actions and objects can capture the actual environment within the planning problem. For example, the set of legal actions can be extracted from the action interface of the ground-truth PDDL and the set of legal objects can be extracted from the problem ground-truth PDDL. However, note that ground-truth PDDLs are not necessarily required; rather, only the legal objects and actions defined therein are required. That is, the ground-truth PDDLs provide a straightforward avenue for accessing the set of legal objects and actions.

To perform an EW, the execution checker executes at least a portion of the legal actions from the set of legal actions on at least a portion of the objects from the set of objects generated by the LLM to determine if each of the executed legal actions is executable/valid. This series of action executions can yield a first metric (e.g., corresponding to m_{d→\hat{d}}), which reflects the percentage of the legal actions being executable within the LLM-generated domain (e.g., LLM-generated objects). The execution checker also executes at least a portion of the actions from the set of LLM-generated actions on at least a portion of legal objects from the set of legal objects to determine if each of the executed LLM-generated actions is executable/valid. This series of action executions can yield a second metric (e.g., corresponding to m_{\hat{d}→d}), which reflects the percentage of LLM-generated actions being executable within the actual domain (e.g., legal objects). Executing actions from the initial state of the domain corresponds to a first EW of length l. To continue the EW by extending the length of the EW, actions are taken from the state of the domain resulting from the first EW to extend the length of the EW by 1. Further EWs can be taken by then taking another EW from the state resulting from the state of domain after the second EW, so on and so forth, until a desired length of EW Tₘₐₓ is reached. That is, each EW can capture a transition of states within the domain by performing action(s) on object(s) within the domain.

To determine the EW score corresponding to the evaluation score used to guide the LLM in PDDL generation and refinement, the first and second metrics can be compared to determine how similar the domain generated by the LLM is to the actual domain. For example, the harmonic mean of the first and second metrics can be taken. That is, the EW score can measure how accurate the LLM-generated parameters are in comparison to the actual parameters required to solve the planning problem.

Note that EW can also determine the actions or actions/object pairs that are invalid or illegal, particularly those which should be valid or legal. This information can also be provided to the LLM to improve PDDL generation and refinement.

In some embodiments, the EW score has a range of [0:1]. That is, a EW score of 0 can represent a complete mismatch between the set of LLM-generated parameters and the set of legal parameters. In contrast, 1 is a perfect EW score, and can represent a perfect match between the set of LLM-generated parameters and the set of legal parameters.

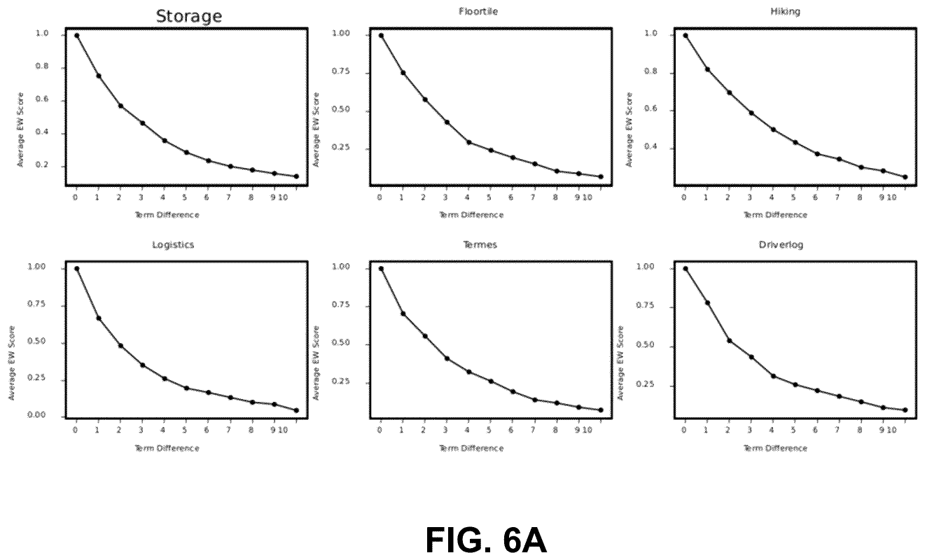

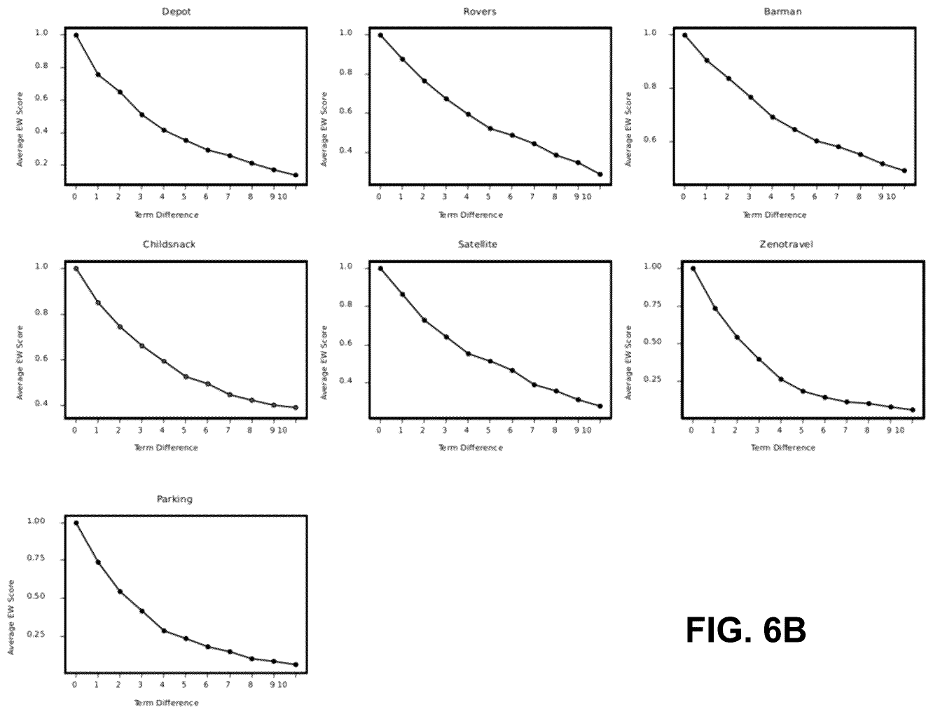

To demonstrate the relationship between m_{d↔\hat{d}} and domain disparity, an artificial set of domains is constructed by modifying real domain PDDLs. Starting with a domain d∈D, and a collection of N problems p_{1:N}∈P^{N}, pairs of altered domains are generated by randomly omitting terms from d. Denoting one pair of modified domains as \hat{d}⁽¹⁾ and \hat{d}⁽²⁾, the domain difference is assessed by counting the number of distinct terms between the two domains. Concurrently, one can calculate [symbol] as the suggested metric for quantifying domain disparity. FIG. 6 presents the results for some example domains. It can be observed that, on average, a greater discrepancy in the number of terms between two domains correlates with a reduced EW score walk. This observation provides additional support to the use of the EW score as an effective measure for domain differences.

In above embodiments, EW scores are used to measure progress with domain generation. In some embodiments, LLMs are used to generate PDDL files. In these embodiments PDDLs are generated for a target domain.

For ease of description, the following focuses on one ground truth domain d∈D, along with one ground-truth problem p∈P. To generate PDDL files, two types of information are provided, namely: (1) a natural language description of the environment corresponding to the domain, which is denoted as d_{NL}, optionally with a domain PDDL template to fill out, and (2) a natural language description of the problem, which is denoted as p_{NL}, optionally with a PDDL template to fill out. Then, by using d_{NL}, p_{NL}, and access to environment action feedback via EW, \hat{d}∈D and \hat{p}∈P are generated.

In prior art, a sequential approach is used to generate both \hat{d} and \hat{p}. With this approach, initially, a domain \hat{d} is generated, which is then subjected to human feedback. Once the domain \hat{d} is verified to be error-free, the problem file \hat{p} is created, informed by the validated domain.

In the PDDL generation and planning method, the lack of human feedback in the settings thereof necessitates the creation of both a valid domain \hat{d} and a problem \hat{p} before any actions can be planned or executed, as these files are prerequisites for any subsequent operations. Consequently, the refinement of either \hat{d} or \hat{p} can only occur after an initial version of both files has been established.

Domain PDDL files typically possess a more complex logic. Thus, domain PDDL files are usually lengthier and demand a greater degree of refinement. Conversely, problem PDDL files are generally more concise, containing only a handful of initial states for the objects within the problem.

Given these considerations, the PDDL generation and planning method prioritizes the generation of a problem PDDL file \hat{p} first, followed by the domain \hat{d}. This approach enables immediate assess of the quality of the generated domain. Moreover, prior works on code generation, tree-of-thought, and self-debug have found that taking multiple samples from the LLM response and taking the best response leads to better performance. However, they often require an evaluation metric on the generated response (such as unit test cases, or execution traces).

In some embodiments, the EW metric described above may be used to serve as an evaluator of the generated domain and/or problem. All these considerations result in Algorithm 1 below to generate the predictions. Note that the ground-truth domain and problem are only used to take exploration walks and evaluate a plan. As used herein, a problem candidate can refer to a set of LLM-generated parameters corresponding to the problem defined by the planning problem and a domain candidate can refer to a set of LLM-generated parameters corresponding to the environment of the problem. The problem and domain candidates may be selected and refined to generate the final output problem and domain parameters (e.g., PDDLs).

Algorithm 1 Generating Domain PDDL and Problem PDDL Using Environment Feedback

Require: Natural language descriptions d_{NL}, p_{NL}, environment action interface.

| | |
|---|---|
| 1: | if DomProp then |
| 2: | ${\hat{d}}_{pr}^{( 1 )} , {\hat{d}}_{pr}^{( 2 )} , … , {\hat{d}}_{pr}^{( {n}_{p} )} ← {LLM}_{{n}_{p}} ( {d}_{NL} ) \{ Generate domain proposal drafts \}$ |
| 3: | ${\hat{p}}^{( i )} ← {LLM}_{1} ( {\hat{d}}_{pr}^{( i )} , {p}_{NL} ) for all 1 \leq i \leq {n}_{p} \{ Problem PDDL candidates \}$ |
| 4: | else |
| 5: | \hat{p}⁽¹⁾, \hat{p}⁽²⁾, . . . , \hat{p}⁽ⁿ^{ₚ}⁾ ← LLMₙ_{ₚ} (p_{NL}) {Problem PDDL candidates} |
| 6: | end if |
| 7: | for i = 1, 2, . . . , nₚ, do |
| 8: | h(i) ← [d_{NL}] {Keep a history of conversation}. |
| 9: | ${\hat{d}}_{best}^{( i )} ← {d}_{NL} \{ Initialize with an empty template \} .$ |
| 10: | for c = 1, 2, . . . , cₘₐₓ do |
| 11: | \hat{d}^{(i,1)}, \hat{d}^{(i,2)}, . . . , \hat{d}^{(i,n}^{_{d}}⁾ ← LLM [symbol] (h⁽ⁱ⁾) |
| 12: | ${\hat{d}}^{( c )} ← arg \text{?} {m}_{d ↔ \hat{d}} ( p , {\hat{p}}^{( i )} ) \{ Evaluate LLM responses using EW \}$ |
| 13: | f^{(c)} ← ( Natural language feedback from EW on d, p. |
| 14: | h⁽ⁱ⁾ ← h⁽ⁱ⁾ + [\hat{d}^{(c)}, f^{(c)}] |
| 15: | ${\hat{d}}_{best}^{( i )} ← arg {max}_{\hat{d} ∈ \{ {\hat{d}}^{( c )} , {\hat{d}}_{best} \}} {m}_{d ↔ \hat{d}} ( p , {\hat{p}}^{( i )} )$ |
| 16: | end for |
| 17: | end for |
| 18: | $\hat{d} , \hat{p} ← arg {max}_{\{ ( {\hat{d}}_{best}^{( i )} , {\hat{p}}^{( i )} ) \vert i = 1 , 2 , ... , {n}_{p} \}} {m}_{d ↔ {\hat{d}}_{best}^{( i )}} ( p , {\hat{p}}^{( i )} )$ |
| 19: | return \hat{d}, \hat{p} {Return the final refined domain and problem PDDLs} |

[symbol]

indicates data missing or illegible when filed

Note that each environment contains N>1 problems, therefore, all problem instances need to be translated into PDDL. Given one problem p₁_{_{NL}} and its generated translation \hat{p}₁, the rest of the problems p_{2:N}_{_{NL}} are translated in a one-shot manner, that is, generating:

$${\hat{p}}_{i} := {LLM}_{1} ( {p}_{{1}_{NL}} , {\hat{p}}_{1} , {p}_{{i}_{NL}} )$$

as the final problem translation for problem i for all 2≤i≤N.

For the output of each pair of domain and problem PDDL files in Algorithm 1, the overall complexity of LLM calls is O(np×n_{d}×cₘₐₓ+N). The complexity of domain generation is O(nₚ×cₘₐₓ×n_{d}). This is because at first, n, problem candidates are generated and for each problem candidate the algorithm goes through a refinement procedure (lines 3, 5, and 7 of Algorithm 1). The refinement is a tree with depth cₘₐₓ (where cₘₐₓ is the maximum number of refinement iterations) (line 10), and at each level of the tree, one node is expanded with n_{d} children (where n_{d} is the number of domain refinement candidates) (line 11), which leads to O(nₚ×cₘₐₓ×n_{d}) complexity. Once the domain is ready, the complexity of task generation for N tasks is O(N) since for each task, the LLM is called once to get a problem translation.

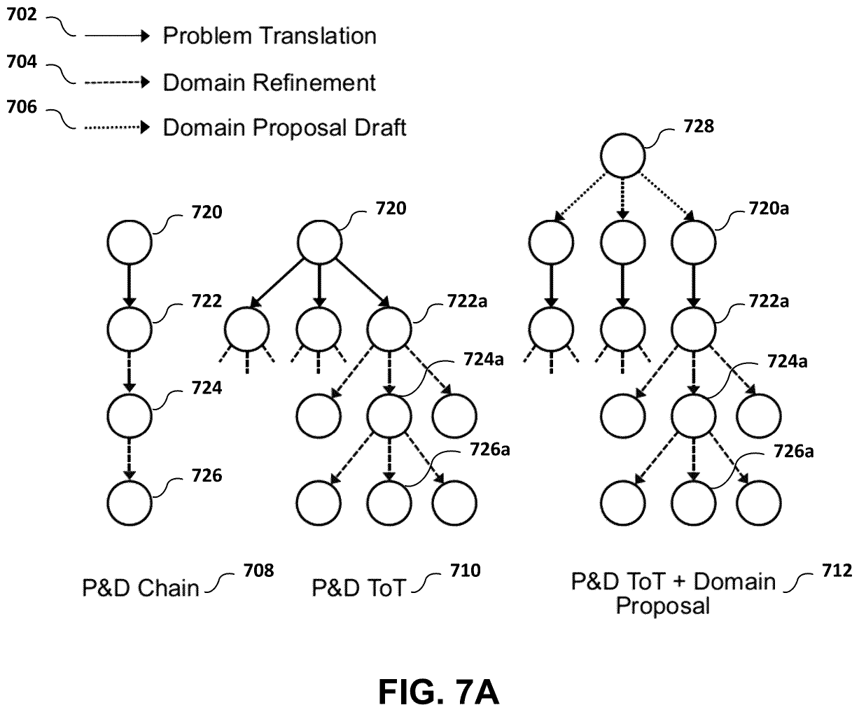

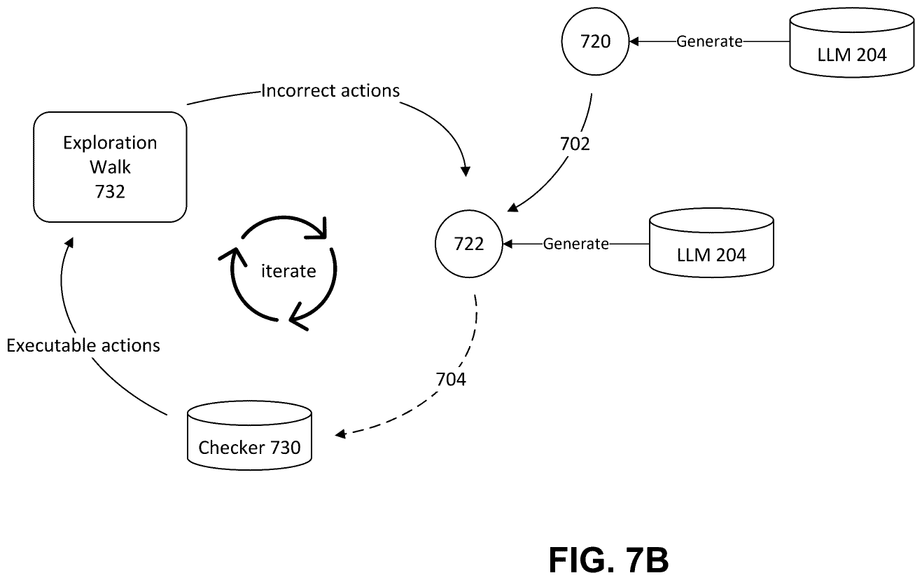

Referring now to FIGS. 7A and 7B, schematics showing the generation of the domain and problem PDDLs are depicted, according to example embodiments. In FIGS. 7A and 7B, arrows 702 correspond to problem translation processes, arrows 704 correspond to domain refinement processes, and arrows 706 correspond to domain proposal draft processes.

Referring first to FIG. 7A, a first method of generating domain and problem PDDLs is shown as P&D chain 708. The LLM (e.g., LLM 204) first generates a problem candidate 720 from the planning problem description corresponding to the natural language description of the planning problem, as described above. The problem candidate 720 is used to generate a corresponding domain candidate 722 through problem translation 702. An iterative process is then performed to improve the domain candidate 722 (domain refinement 704). As depicted in FIG. 7A, the domain candidate 722 is refined into domain candidate 724, which is then refined into domain candidate 726 and output. At each refinement step (represented by an arrow 704), EW is performed using the problem candidate and the domain candidate of the current iterative step. In particular, EW is first performed on domain candidate 722 to determine the EW score for the domain candidate 722 and problem candidate 720. The EW and/or any mismatching executions (e.g., legal actions that should be illegal, etc.), resulting domain states, etc. determined by the execution checker may be provided to the LLM to refine the domain candidate 722. A LLM can also back-translate the domain and problem candidate into natural language for better interpretation by the LLM during the refinement process. The LLM can also provide context and feedback for the domain generating LLM for the next iteration, for example by identifying errors and prompting the domain generating LLM to address the errors. Note that the EW performed at any refinement stage can be any suitable length of one or greater. This refinement process is repeated for domain candidate 724 to generate domain candidate 726.

The method 708 is also shown in FIG. 7B. As depicted in FIG. 7B, the LLM 204 generates a problem candidate 720 as described above. The LLM 204 can then use the problem candidate 720 to generate the domain candidate 722 through problem translation 702. The execution checker 730 performs EW 732 as described above to determine the EW score and incorrect/mismatched actions and domain states, which are provided to the LLM 204 to refine the domain candidate 720. The domain refinement process can be iterated a desired number of times (cₘₐₓ).

In some embodiments, a refinement interface can be utilized for domain refinement by the LLM. In particular, prompting the LLM to regenerate the domain can result in redundant output generation and in the LLM modifying incorrect portions of the domain. For example, the LLM can have a high tendency towards changing the action interface signature, despite the instructions explicitly mentioning not to change the signature. To address this issue, an interface can be provided for the LLM to modify a domain. That is, the LLM is not instructed to generate or modify the domain candidate directly. Instead, the LLM is prompted to provide computer-readable instructions for modifying the domain candidate, where the instructions are then executed through the interface to modify the domain. An example embodiment of the refinement interface is a Python™ interface. In particular, the interface provides the LLM with two functions, one for adding/modifying predicates and another for modifying actions in the action interface. An example of the two functions is provided below:

```
add_or _update_ predicates (
  predicates: List [ str ]
)
modify_action (
  action_name: str ,
  new_ preconditions: List [ str],
  new_effects: List [ str ]
)
```

The first function adds predicates to the list of already created predicates, and the second one modifies the preconditions and effects of a particular action. It is also possible to generate the domain PDDL one action at a time, and gradually create predicates. However, the use of the interface can allow for more flexibility, such as more convenient implementation as well as enabling the LLM to modify an action several times, or to introduce predicates in between reasoning steps.

During domain refinement, the EW score may be modified to improve domain refinement. In particular, when generating domain refinement strategies, the LLM may make mistakes, hence failing before even the EW score can be computed. For instance, the modification may be invalid, containing syntax error, or failing to fill parts of the template. To facilitate incorporating these into the refinement process, the EW score can be modified to penalize (e.g., adding a negative modifier) these mistakes and invalid modifications. Table 2 shows example LLM errors and the corresponding modifiers to the EW score (note that other modifier values are also possible in other embodiments). In particular, the EW metric can be negatively modified for: no possible/executable action in the domain, invalid domain parameters (e.g., invalid syntax), missing domain parameters (e.g., no effect parameters for an action), invalid domain modifications, and no domain modification.

TABLE 2
EW score modifications

| Description | Rating |
|---|---|
| Exploration Walk Executable | 0 ≤ EW Score ≤ 1 |
| No initial action possible | −1 |
| Invalid domain modification | −2 |
| (e.g., undefined predicates) | |
| Domain sanity check failure | −3 |
| (e.g., empty effect list) | |
| Invalid domain modification | −4 |
| No domain modification | −5 |

In some embodiments, when the EW score is perfect (e.g., equals 1.0), the planner can be executed using the current problem and domain candidates (e.g., evaluate V_{d,p}(.)). The refinement process can then be terminated early (e.g., before reaching cₘₐₓ) by outputting the current problem and domain candidates if the planner is able to generate a valid plan for solving the planning problem using the current problem and domain candidates.

Referring back to FIG. 7A, a second method of generating domain and problem PDDLs is shown as P&D ToT 710. Analogous to 708, a problem candidate 720 is first generated from the planning problem description. In contrast to 708, a plurality of domain candidates are generated at each iterative step. In particular, a plurality of domain candidates 720 are first generated for the problem candidate 720 (e.g., line 11 of Algorithm 1). Each of the domain candidates 720 is evaluated with the problem candidate 720 using EW (e.g., line 12 of Algorithm 1), as described above. Specifically, the best domain candidate from the plurality of domain candidates 720 can be selected and iterated on according to the EW score (e.g., line 15 of Algorithm 1). For example, the domain candidate 722a exhibited the highest EW score and is accordingly refined to generate another plurality of domain candidates 724. EW is also performed on the plurality of domain candidates 724 and the problem candidate 720, from which domain candidate 724a is selected for further refinement based on EW score. At the subsequent iteration, a plurality of domain candidates 726 are generated from the domain candidate 724a, from which domain candidate 726a is output based on EW score.

Also depicted in FIG. 7A is a third method of generating domain and problem PDDLs, shown as P&D ToT+Domain Proposal 712. In contrast to 710, a plurality of problem candidates 720 are generated from the planning problem description (e.g., line 5 of Algorithm 1). In 712, a plurality of domain candidates 722 are generated for each problem candidate 720a (e.g., lines 7 and 11 of Algorithm 1). Analogous to 710, each of the plurality domain candidates 720 is refined to generate the domain candidates 724 and 726 via selected domain candidates 722a and 724a. Note that the refinement of the domain candidates corresponds to the respective problem candidate (720a), where the refinements of domain candidates for each problem candidate (e.g., each “branch” of the refinement process) are independent. That is, each EW can be performed using a domain candidate and the respective problem candidate (of the branch). After refinement, domain candidate 726a is determined to be the best domain candidate for the problem candidate 720a. Specifically, the domain candidate 726a and problem candidate 720a can form one domain problem candidate pair where the number of pairs is equal to the number of generated problem candidates. One pair of the domain and problem candidates can be selected for output based on their EW score (e.g., lines 18 and 19 of Algorithm 1).

In a further embodiment, a domain proposal 728 can be used to generate the problem candidate 720 or a plurality thereof (706). Note that predicate design can be challenging for the LLM. Therefore, the LLM can be first prompted to draft a domain proposal 728, and to then generate the problem candidate 720 based on the predicates found in the draft. This way, the LLM can first generate domain-aware predicates, and then generate the problem candidate(s). The domain proposal 728 can identify parameters that should be present in the environment, for example corresponding to the predicates in the domain, but is not required to comprise a full description of the domain and not required to be generated as a domain PDDL. Note that although FIG. 7A depicts the plurality of problem candidates 720 being generated from a single domain proposal 728, in some embodiments, a plurality of domain proposals 728 can be generated. In particular, a respective problem candidate 720 can be generated for each domain proposal (e.g., lines 2 and 3 of Algorithm 1).

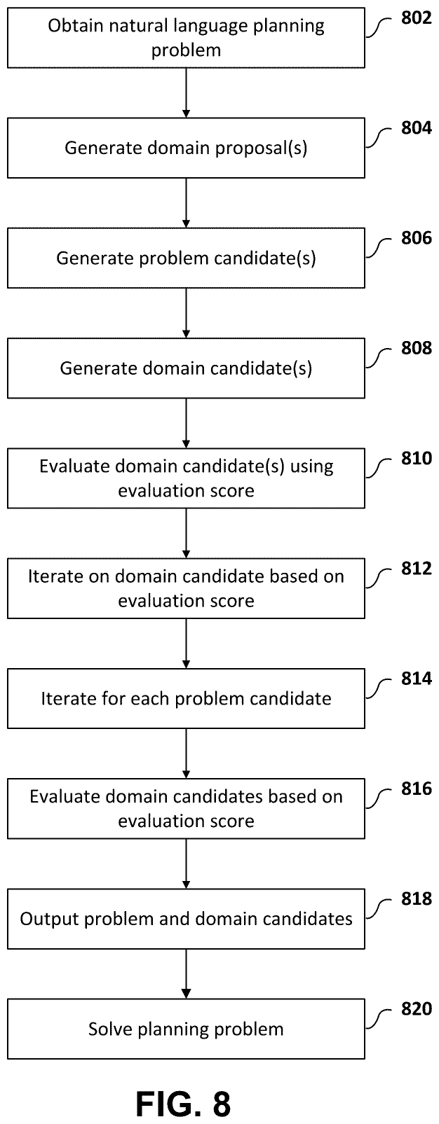

Now referring to FIG. 8, a method of solving a natural language planning problem is depicted, according to an example embodiment. At 802, natural language description of the planning problem is obtained, as described above. The description of the natural language planning problem can comprise the domain description and the problem description. At 804, one or more domain proposals can be generated by one or more LLMs using the description of the planning problem, as described above. In particular, a first predetermined number of domain proposals can be generated.

At 806, one or more problem candidates can be generated by the LLMs, for example using a problem generation template. Each problem candidate can be a set of machine-readable parameters corresponding to the problem to be solved by the planning problem (e.g. problem PDDL file). A problem candidate can be generated for each domain proposal, that is, the first predetermined number of problem candidates can be generated. At 808, one or more domain candidates can be generated by the LLM for each problem candidate by the LLMs from the respective problem candidate, for example using a domain generation template. Each domain candidate can be a set of machine-readable parameters corresponding to the environment of the planning problem. In particular, a second predetermined number of domain candidates can be generated for each problem candidate.

At 810, for each problem candidate, the one or more domain candidates are evaluated using EW with respect to the respective problem candidate, as described above. The EW can be for a pre-defined length. One of the domain candidates can be output or iterated on, where the output/iterated domain candidate is determined according to the EW score. At 812, said domain candidate can be refined in a subsequent iteration, as described above. In particular, feedback can be provided to the LLMs based on the results of EW to refine the domain candidate. The refinement process can be iterated for a third predetermined number of times. At 814, the refinement process is repeated for each of the problem candidates. At 816, the refined domain candidates are evaluated against each other using the EW score. That is, the refined domain candidate with the highest EW score and the corresponding problem candidate are output at 818. At 820, a planner can process the output domain and problem candidates to generate a plan which solves the planning problem.

### Experimental Results

Different PDDL generation methods were compared using a dataset comprises PDDL files from real environments, and taking a combination of domain PDDLs using two prior-art methods. Natural domain descriptions were generated for all PDDL files by back-translating them using GPT-4™, and the translations were manually inspected and modified for correctness. For each environment, one domain PDDL d and N=10 problem PDDLs p_{1:N} were considered. In the experiments, one problem was used for domain translation and EW evaluation, and all problems were used for evaluating a final domain response. The Blocksworld environment was reserved as an in-context example for prompting the LLM. For instance, when prompting the LLM to generate problem translation from natural language, for example, LLM(p_{NL}), the LLM with an example from Blocksworld was also prompted. As such, the Blocksworld environment itself was not evaluated in the evaluations.

The experiments used GPT-4™ (gpt-4-1106-preview) as the LLM since models with lower capability may struggle with syntax errors. Each algorithm ran for four seeds and the Best@4 metric is computed, which takes the highest score among the four seeds. Two metrics were reported, namely:
(1) tasks solved, measuring the fraction of the N=10 tasks successfully solved (Equation (1)), and
(2) EW score, comparing the final domain through running exploration walks on all N problems (Equation (2) with Tₘₐₓ=10). The original fast-downward library was used for planning, the modified fast-downward library from text-world for Python™-compatible state explorations, and the VAL™ library for validating plans.

Table 3 shows the final results on various environments. As can be seen, the PDDL generation and planning solved seven (7) out of 10 environments, compared to 3 solved by the baseline. Two more environments (Barman and Childsnack) were close to being solved due to their high EW scores. The P&D Tree method (e.g., 710) achieved an average task solved rate of 0.66 and an average EW score of 0.84, outperforming the baseline's 0.34 task solved rate and 0.53 EW score. The rightmost column of Table 3, entitled P&D Tree+DomProp (e.g., 712), represents an example PDDL generation and planning method.

In Table 3, the results over four seeds are shown. The number of seeds a domain was successful in generating a correct domain is also shown. The number of seeds that succeeded in generating correct domains for the Termes, Movie, Miconic, Grippers, Hiking, Grippers-ood, and Floortile, are 4, 3, 3, 3, 2, 1, 1, respectively.

Regarding the computational cost, 11.00 million input tokens and 8.36 million output tokens were used for obtaining the results in Table 3 using the GPT-4™ model.

TABLE 3
Best@4 (Tasks solved/Exploration Walk) for different domains. For intrinsic
planning no domain is generated, therefore the EW score is not defined.

| | Intrinsic | Intrinsic | P&D Chain | P&D Tree | P&D Tree + DomProp |
|---|---|---|---|---|---|
| | No CoT | CoT | (n_{d} = 1, nₚ = 1) | (n_{d} = 10, nₚ = 5) | (n_{d} = 10, nₚ = 5) |
| Barman | 0.00/— | 0.00/— | 0.00/0.93 | 0.00/1.00 | 0.00/1.00 |
| Childsnack | 0.00/— | 0.00/— | 0.00/0.57 | 0.00/1.00 | 0.00/1.00 |
| Driverlog | 0.00/— | 0.00/— | 0.00/0.05 | 0.00/0.05 | 0.00/0.60 |
| Floortile | 0.00/— | 0.00/— | 0.00/0.07 | 0.90/0.94 | 0.00/0.07 |
| Grippers | 0.40/— | 0.60/— | 0.10/0.39 | 1.00/1.00 | 1.00/1.00 |
| Grippers-ood | 0.30/— | 0.30/— | 0.30/0.35 | 0.70/0.72 | 1.00/1.00 |
| Hiking | 0.00/— | 0.00/— | 0.00/1.00 | 1.00/1.00 | 1.00/1.00 |
| Miconic | 0.90/— | 1.00/— | 1.00/0.84 | 1.00/0.85 | 1.00/1.00 |
| Movie | 1.00/— | 1.00/— | 1.00/0.07 | 1.00/0.85 | 1.00/0.86 |
| Termes | 0.00/— | 0.00/— | 1.00/1.00 | 1.00/1.00 | 1.00/1.00 |
| Average | 0.26/— | 0.29/— | 0.34/0.53 | 0.66/0.84 | 0.60/0.85 |

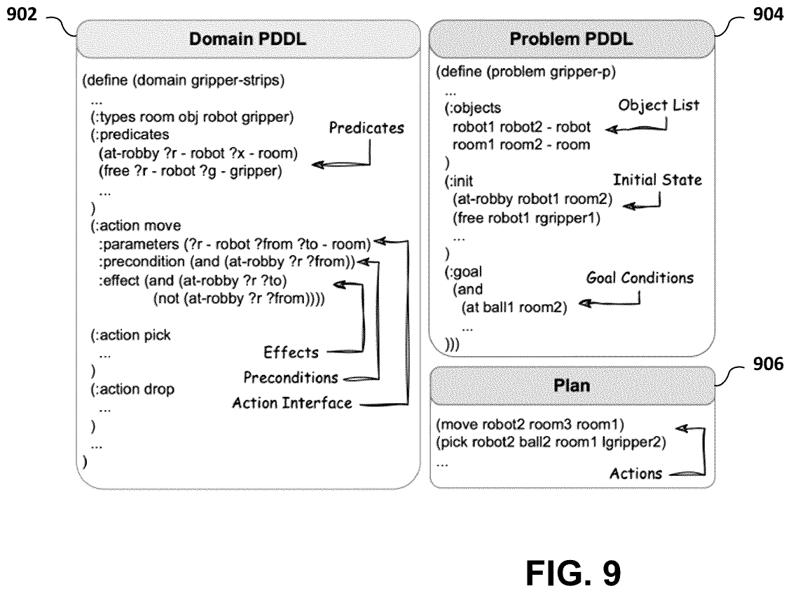

FIG. 9 shows an annotated example domain 902, problem 904, and plan 906 PDDLs for the Grippers environment. The domain PDDL 902 determines predicates and comprises the action interface comprising action parameters, preconditions, and effects. Predicates such as at-robby keep track of object states (e.g., whether a particular robot is in a particular room); defining suitable predicates is part of domain design. The problem PDDL comprises the object list, the initial state of the objects, and the goal conditions of the objects (target result). The plan 906 comprises the series actions required to transition from the initial state to the goal state.

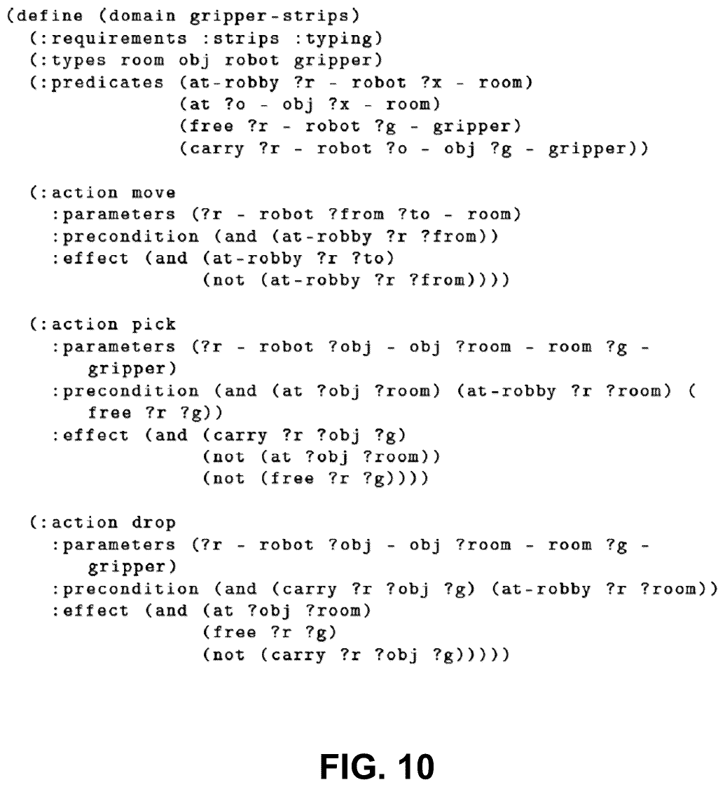

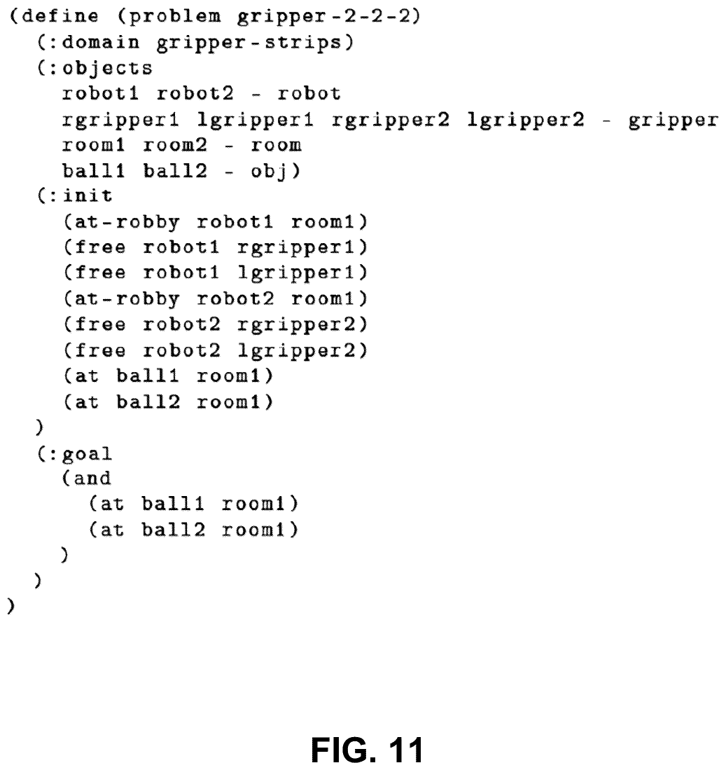

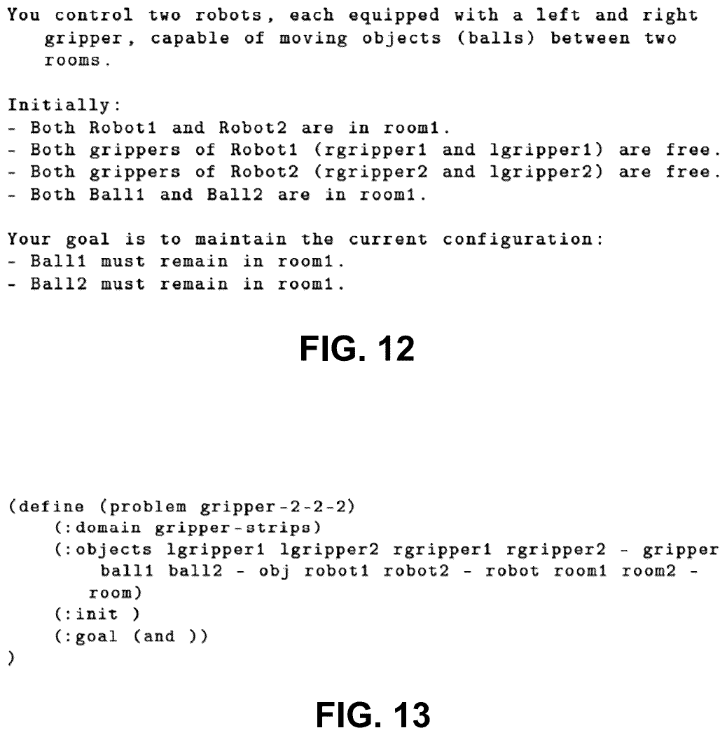

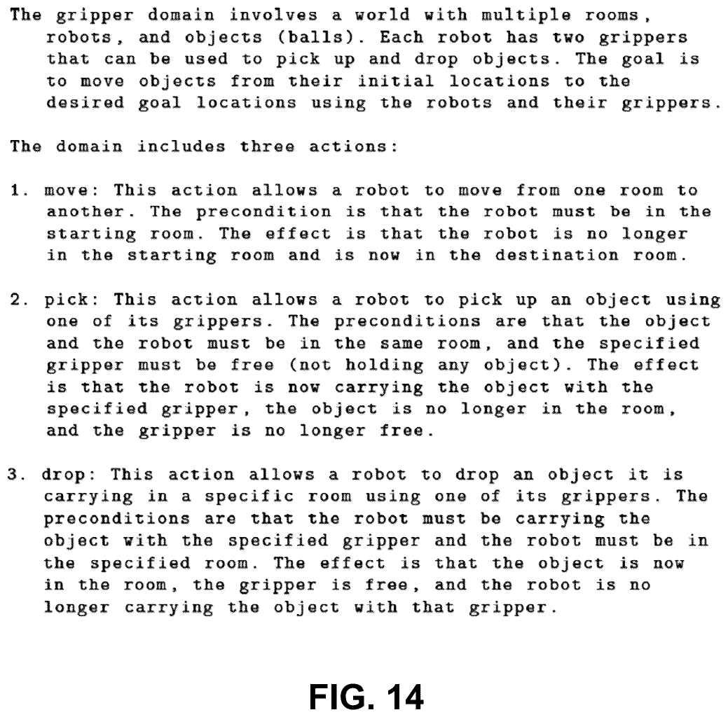

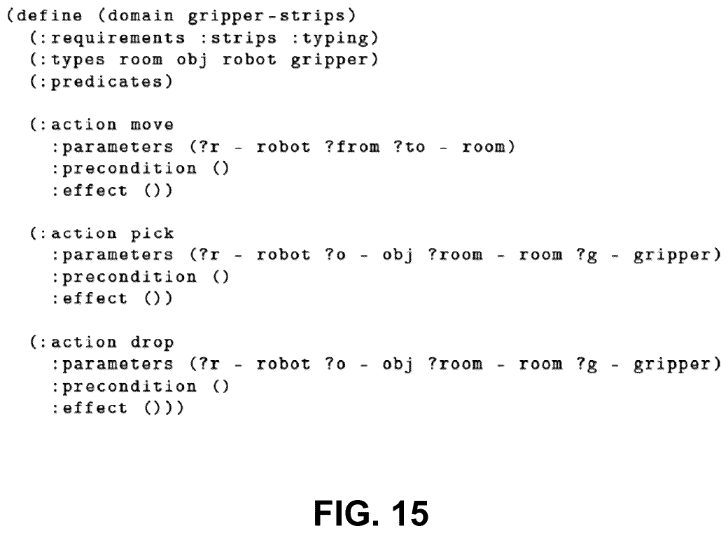

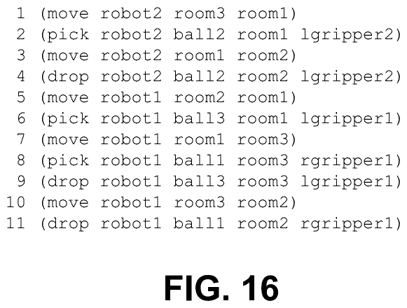

FIGS. 10 to 16 show some dataset examples of files for the Grippers environment, wherein FIG. 10 shows Grippers domain PDDL (that is, the ground-truth domain d of ground truth PDDL domain), FIG. 11 shows the Grippers problem PDDL (that is, one ground-truth problem p), FIGS. 12 and 13 show Grippers problem natural language and Grippers problem template PDDL, respectively (that is, problem natural language description along with a PDDL template with the list of objects), FIGS. 14 and 15 show Grippers domain natural language and Grippers domain PDDL template, respectively (that is, domain natural language description along with a PDDL template for action interfaces d_{NL}). FIG. 16 show a Grippers problem plan for solving the planning problem.

More particularly, in the Grippers environment of FIGS. 10 to 16, there are several rooms containing robots and boxes. Robots can move balls between rooms using their grippers. Given an initial setting of robots and balls, the goal is to move specific boxes to specific rooms. The domain determines action interfaces. For instance, the move action for moving a robot from one room to another has three parameters: robot r, departure room from, and destination room to, shown by (?r—robot ?from ?to—room). Each action has preconditions and effects, which comprise the main logic of the domain for determining the actionability of an action. In the case of the move action, the precondition is that the robot must be in the from room (shown by (at-room ?r ?from)), and the effect is that it will no longer be in that room and will be in the to room. Predicates such as at-room keep track of object states, and defining suitable predicates is a crucial part of domain design. A problem PDDL p specifies the initial state of robots, boxes, rooms, and the final goal. For instance, (at-robby robot2 room3) means that robot2 is initially at room3, and (free robot2 rgripper2) means the right gripper rgripper2 of robot2 is free. To specify a goal condition that ball1 must eventually be moved to room2, one can use (at ball1 room2). A plan constitutes a consecutive sequence of actions to reach the goal. For instance, one action could be (move robot2 room3 room1), which moves robot2 from room3 to room1. If robot2 is not already in room3, this action is considered illegal, and the environment or planner will produce an error.

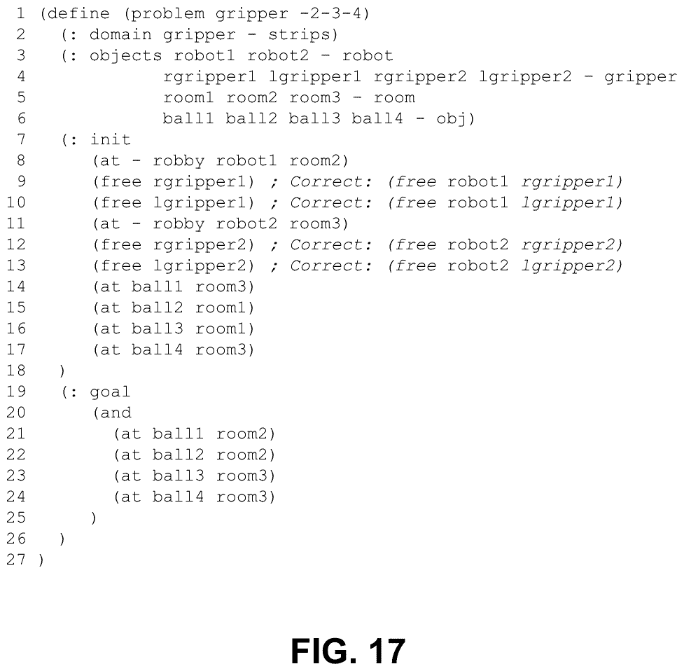

Note that predicate design can be delicate. Consider the Grippers environment, where each robot has two grippers: left gripper and right gripper. In one experiment, one of the main predicates that the LLM incorrectly generated is the free predicate. This predicate keeps track of whether a gripper is free or not. Therefore, at first sight, (free ?g—gripper) seems a natural choice to show a particular gripper is not occupied and hence is capable of picking a ball. However, when designed this way, in contrast to (free ?r—robot ?g—gripper) (e.g., missing the robot argument), this small detail can cause the final domain to be invalid. The reason is that there would no longer be any association between a robot and its two grippers. Therefore, on the incorrect domain, one robot may be able to pick up an object with the gripper of another robot. This incorrect design for the free predicate can cause the generated PDDLs to be invalid. FIG. 17 shows an example of incorrectly generated Grippers problem PDDL. Note that the free predicate has only one parameter.

An additional example of criticality of predicate design can be illustrated using the Barman environment. The Barman environment involves actions related to manipulating containers (e.g., shot glasses, shakers) to prepare and serve drinks using various ingredients. One of the key predicates used in the domain is (used ?c—container ?b—beverage), which keeps track of which beverage has been used in a specific container. This is important for actions like refilling or cleaning, where knowing the specific beverage type is essential to ensure conformance with the environment rules (e.g., a container can be refilled only with the beverage that it already had; otherwise, it needs to be cleaned first). However, when an LLM is used to generate the domain, it can sometimes mistakenly omit the beverage argument, simplifying the predicate to (used ?c—container). While this might appear like a harmless simplification, as the container usage is still tracked, this change results in significant problems in the overall domain behavior. Since the beverage is no longer specified, the domain can no longer differentiate between containers used for different types of beverages. This can lead to situations where a container that has already been used for one beverage can be incorrectly treated as if it can hold another beverage without requiring proper cleaning or resetting actions. Such a mistake can cause the final domain to generate invalid plans, as the planner will fail to ensure that containers are used properly with respect to their contents, leading to cascading errors in tasks like mixing drinks, cleaning containers, or pouring from shakers.

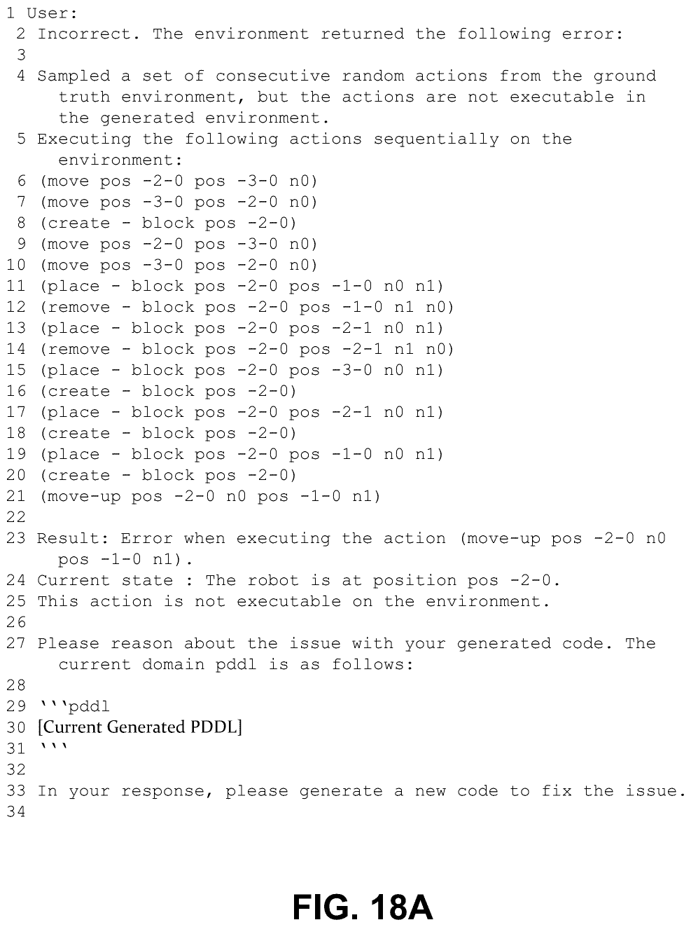

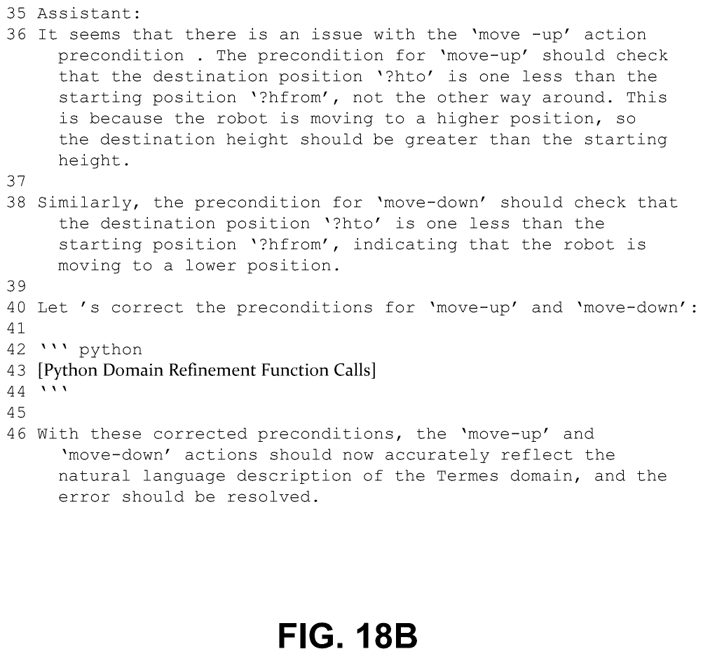

An example of the domain refinement process is shown in FIGS. 18A and 18B, which depict domain feedback from the Termes environment, where the LLM output refinement results into a correct domain.

To generate natural language description of domains, problems, and environment states for the experiments, the following strategies were used. Note that the natural language descriptions of the domains, problems, and environment states may be used during the refinement process, for example in providing feedback to the LLM for the next iteration.

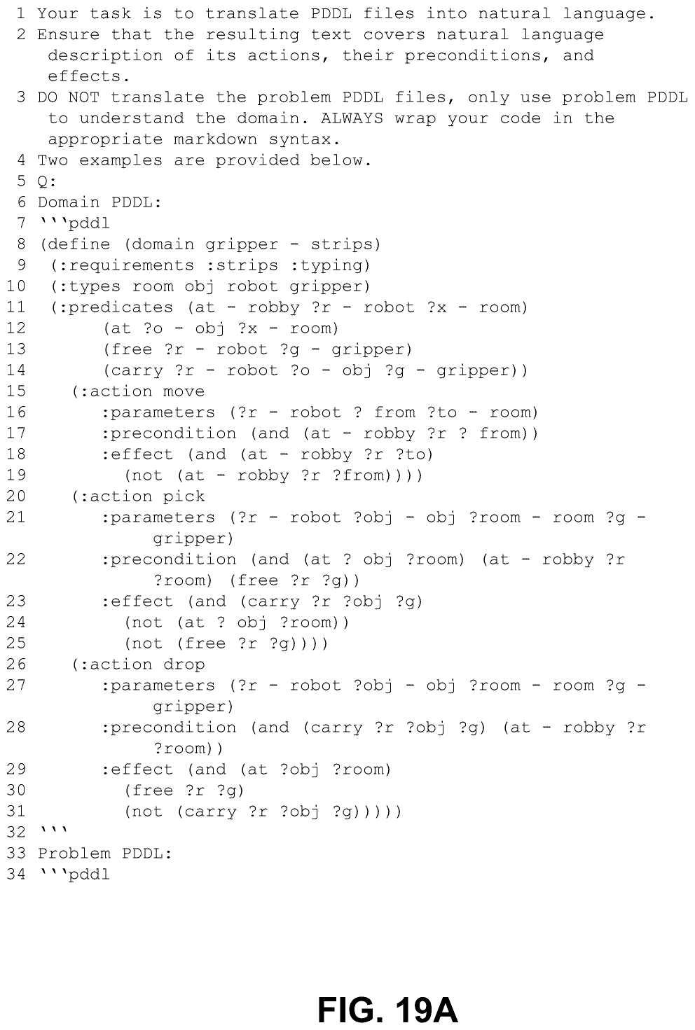

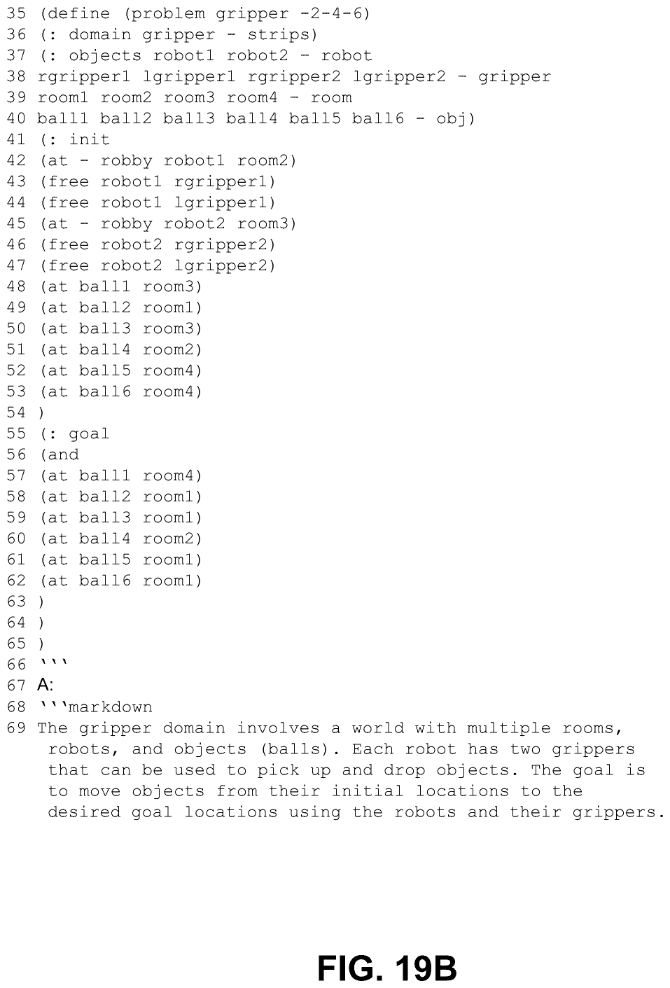

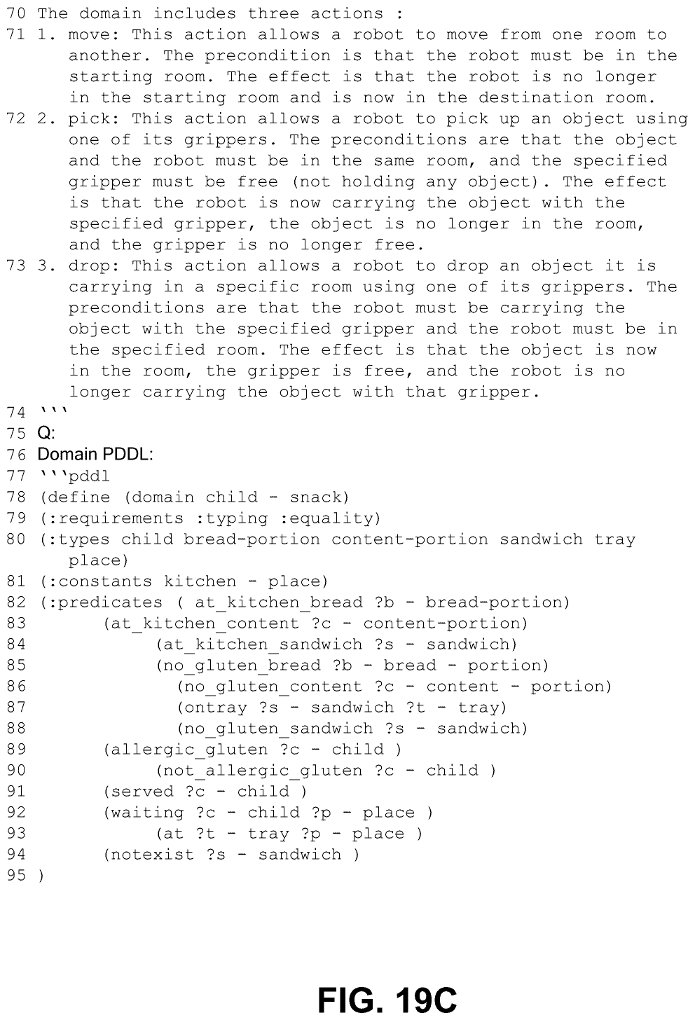

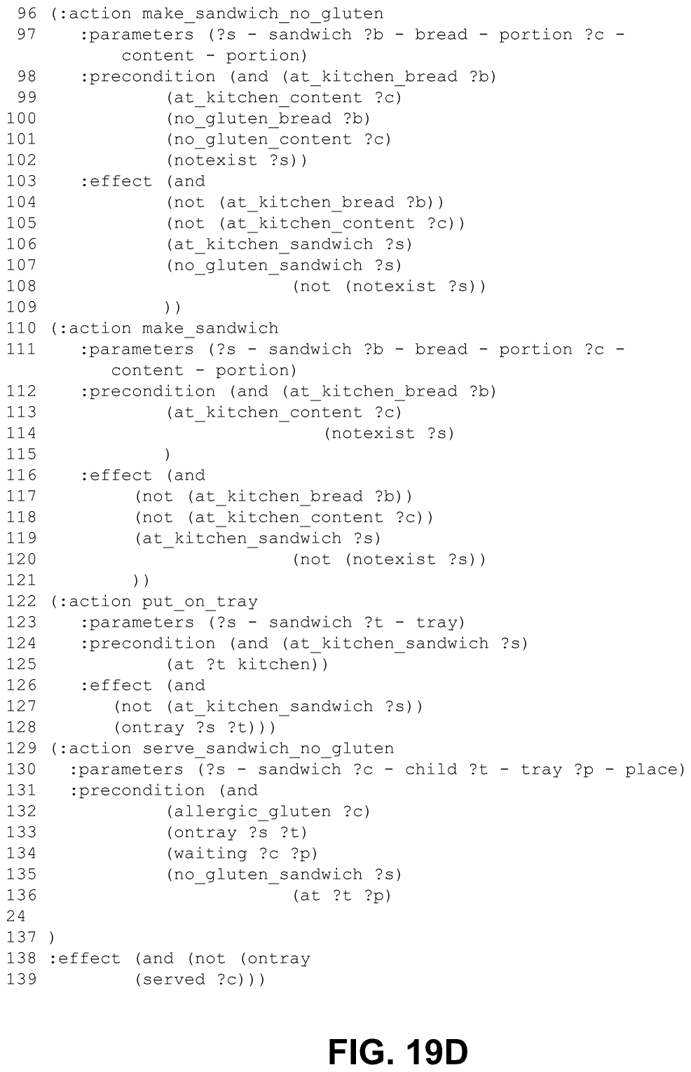

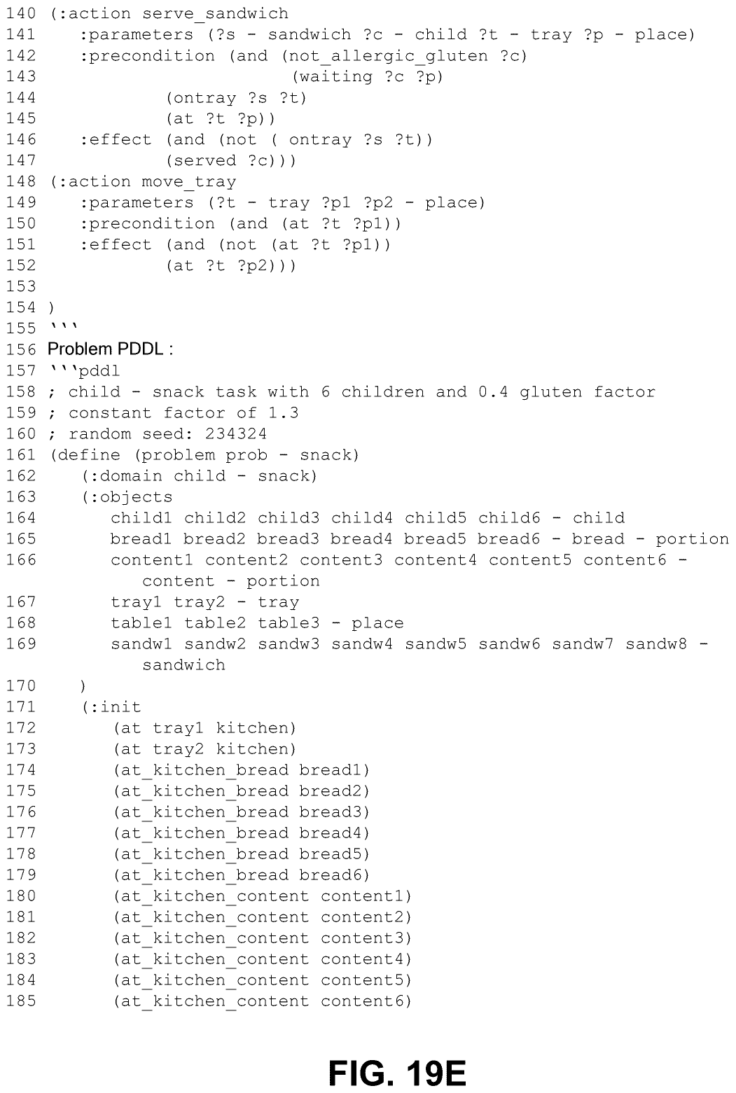

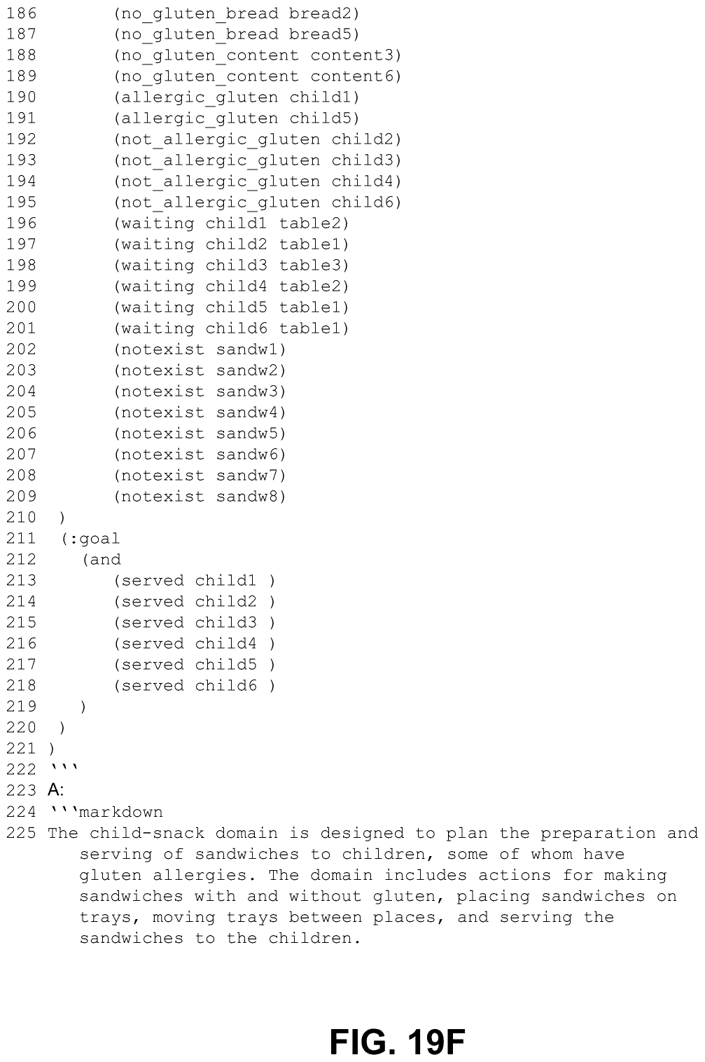

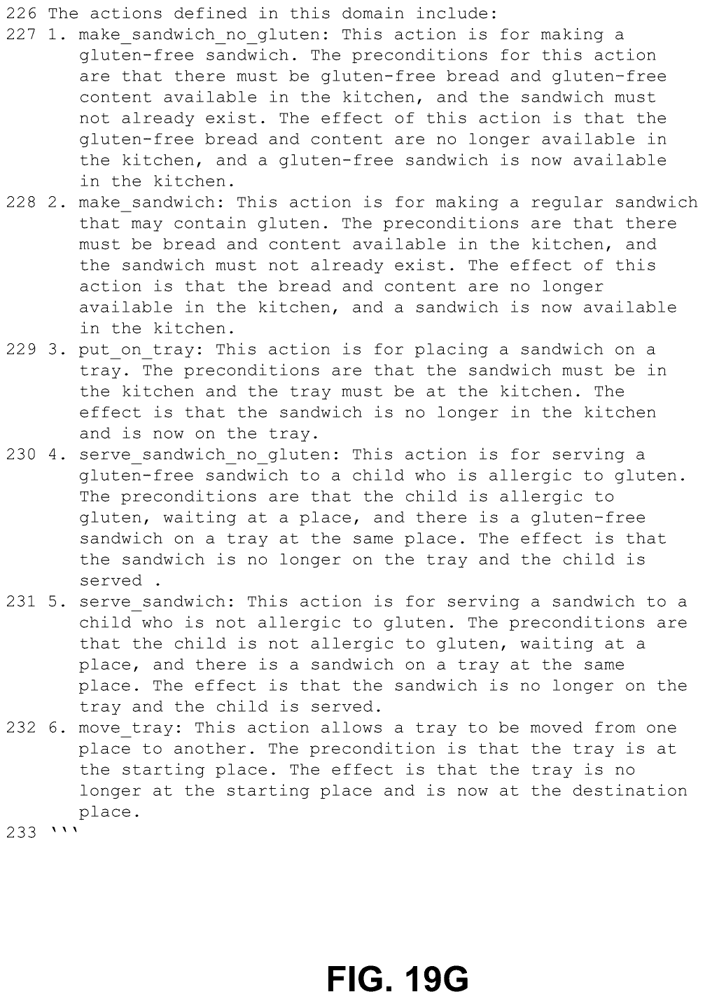

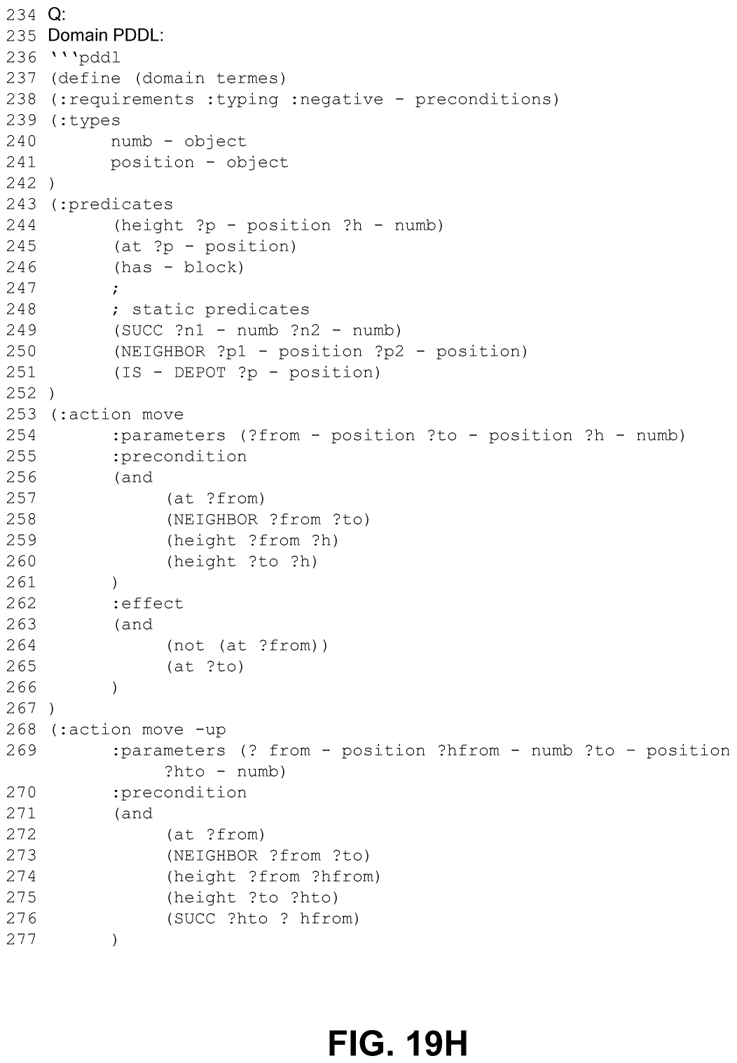

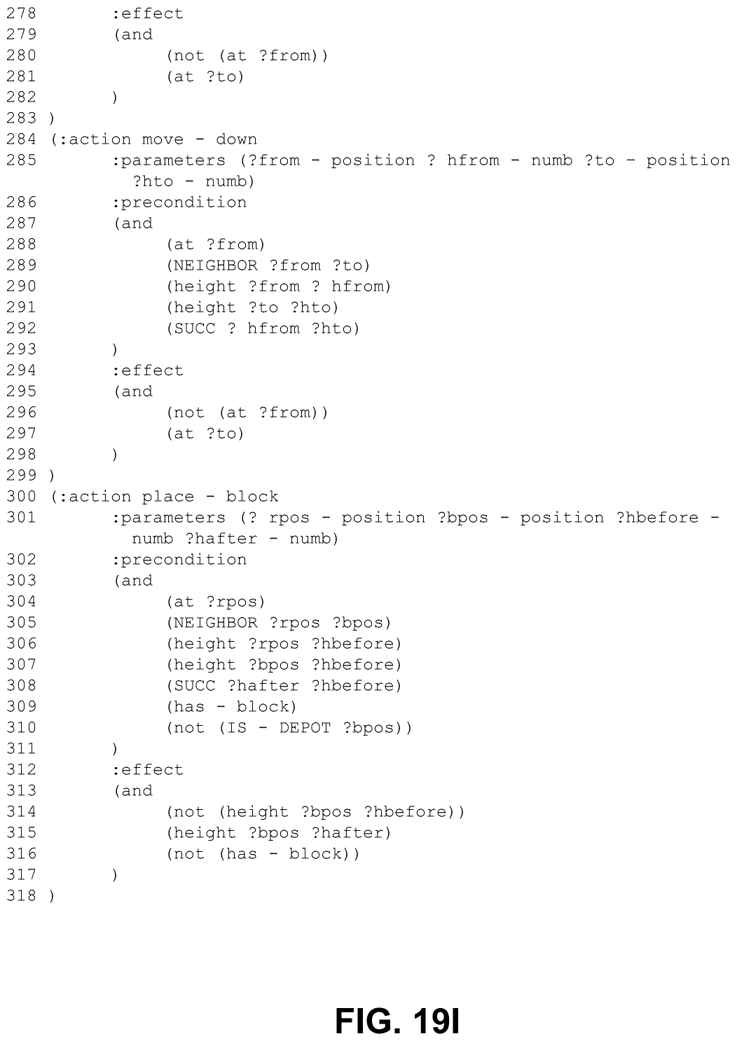

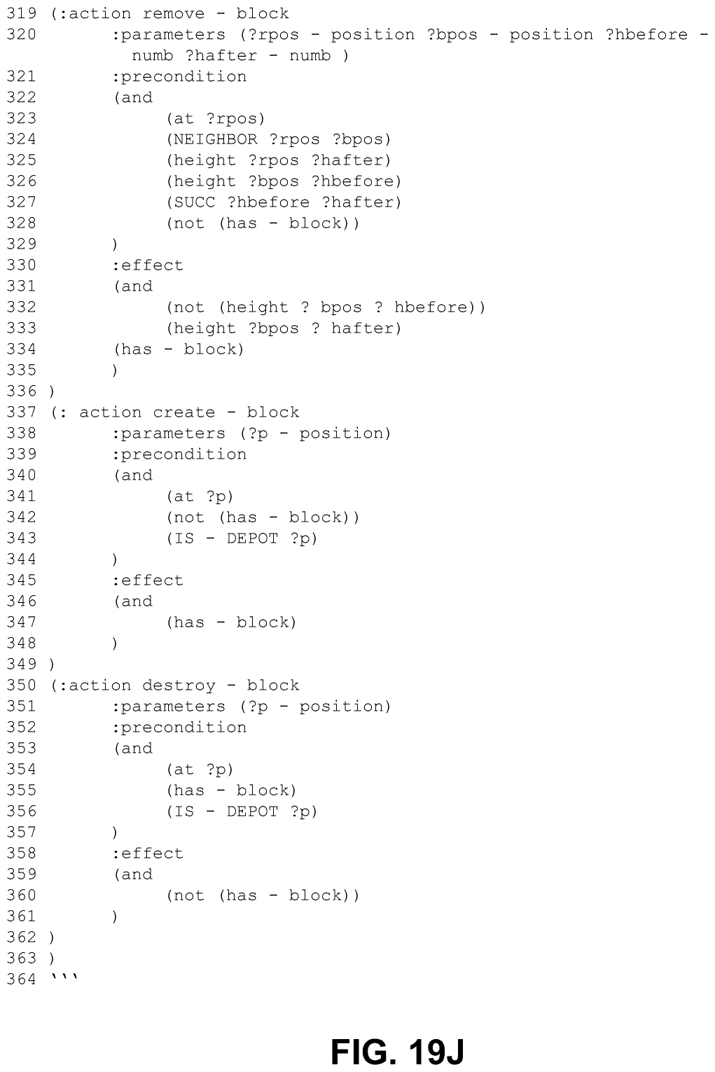

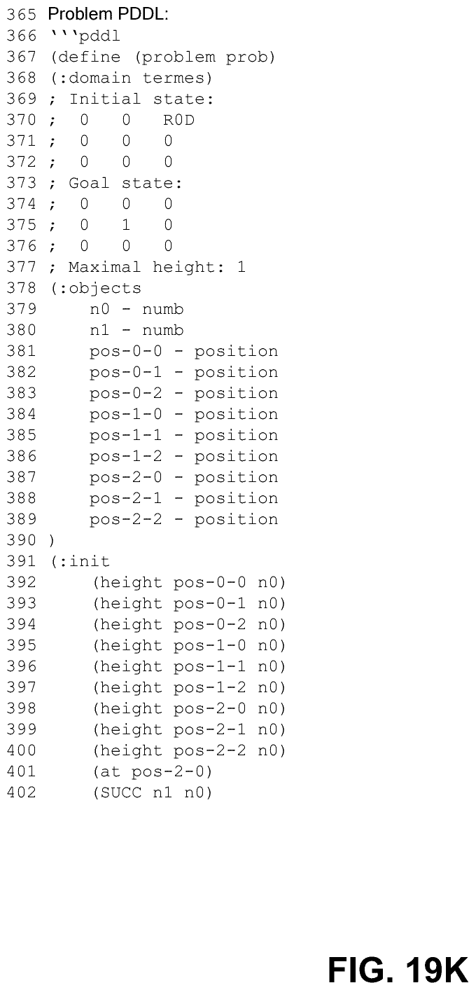

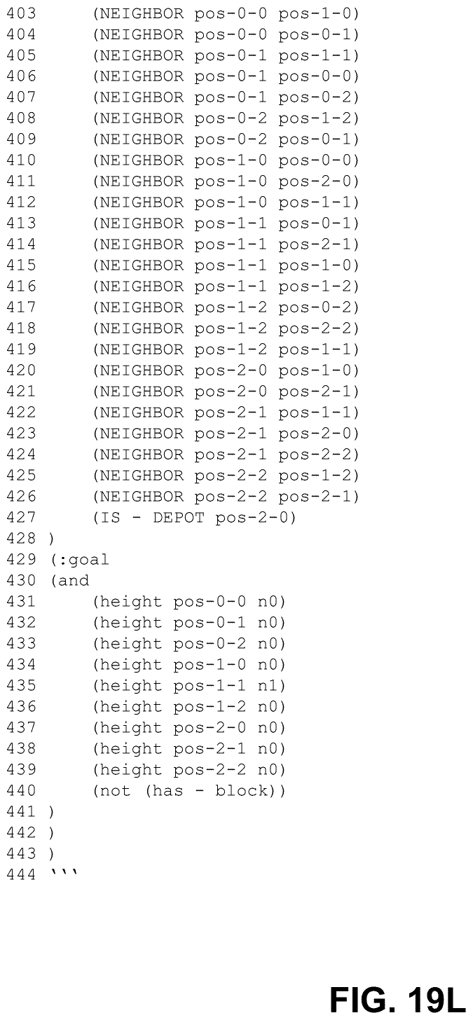

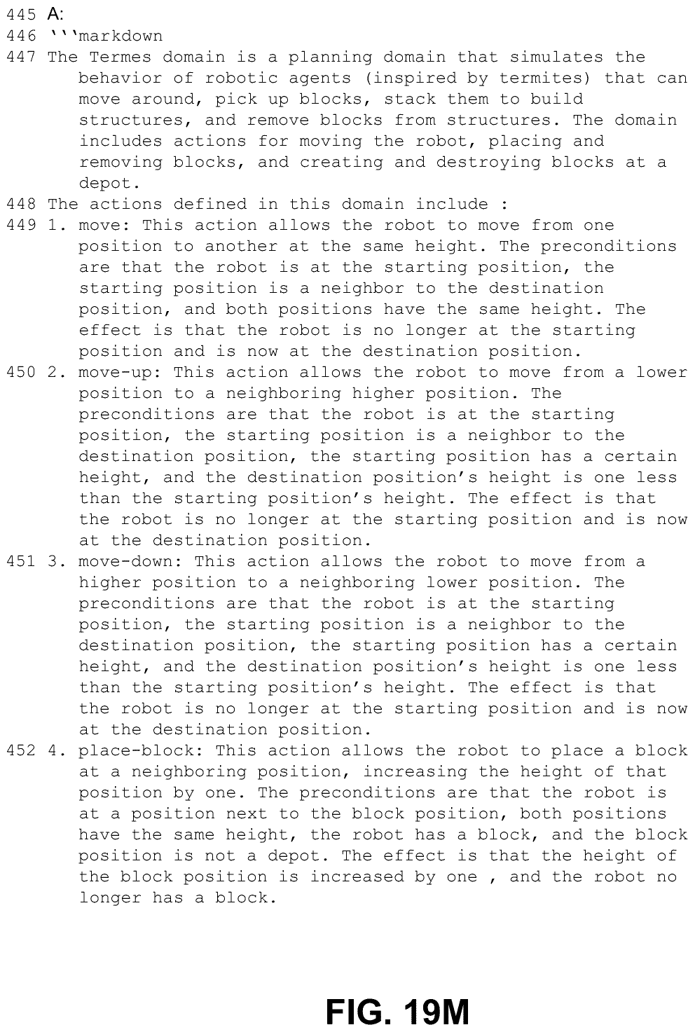

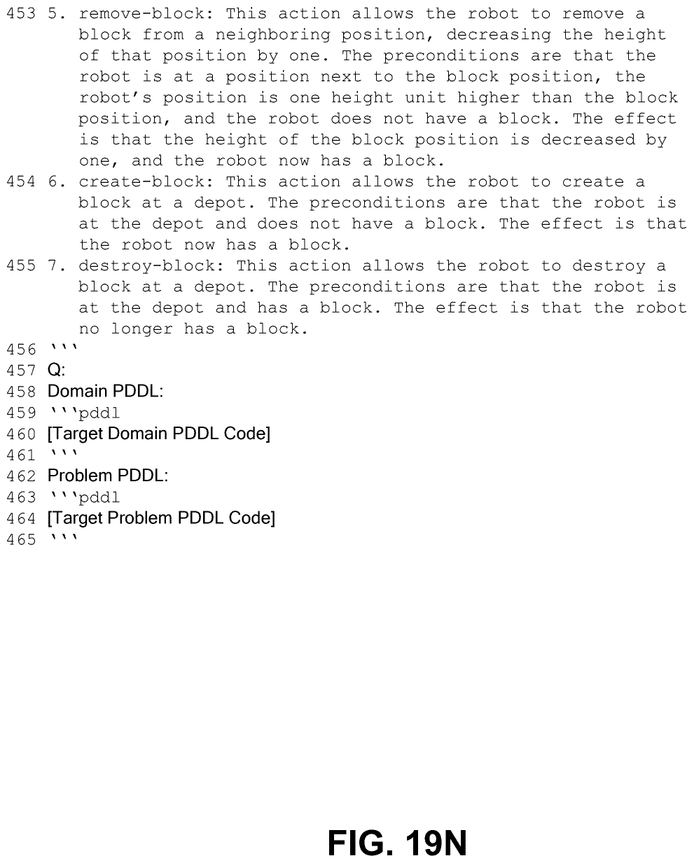

Domain: A few-shot translation strategy was used. Three diverse environments of “Grippers”, “Childsnack”, and “Termes” were selected to manually (with assistance of GPT-4™) curate domain translation. Then, these three domains were used as three-shot in-context examples to translate the rest of domains. The example prompt is provided in FIGS. 19A to 19N, which show a domain back-translation prompt template, with domain PDDL and problem PDDL placeholders for each target domain.

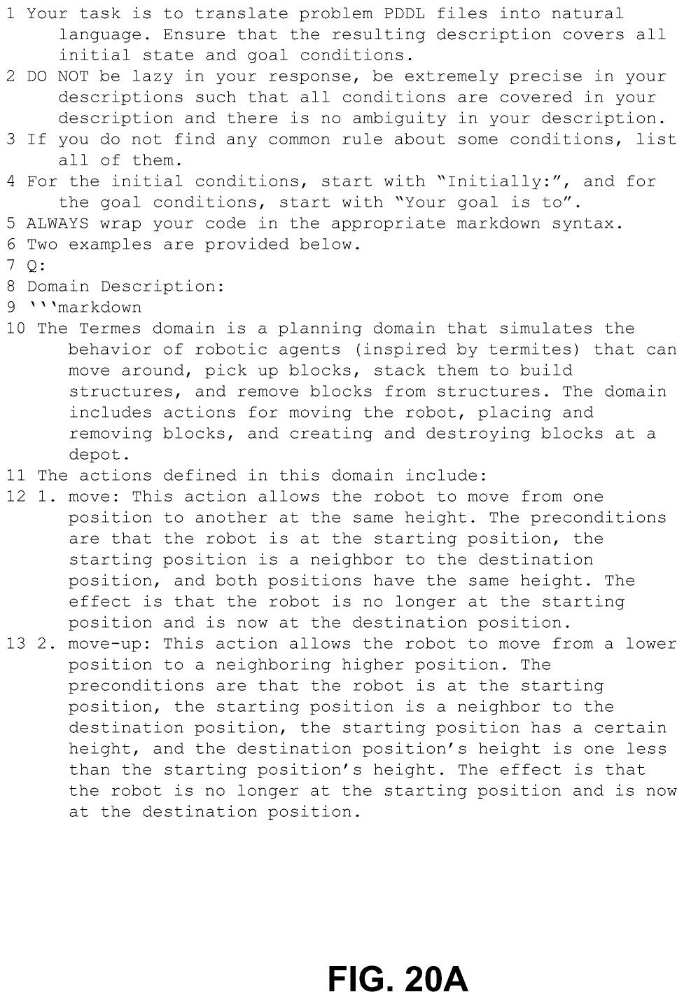

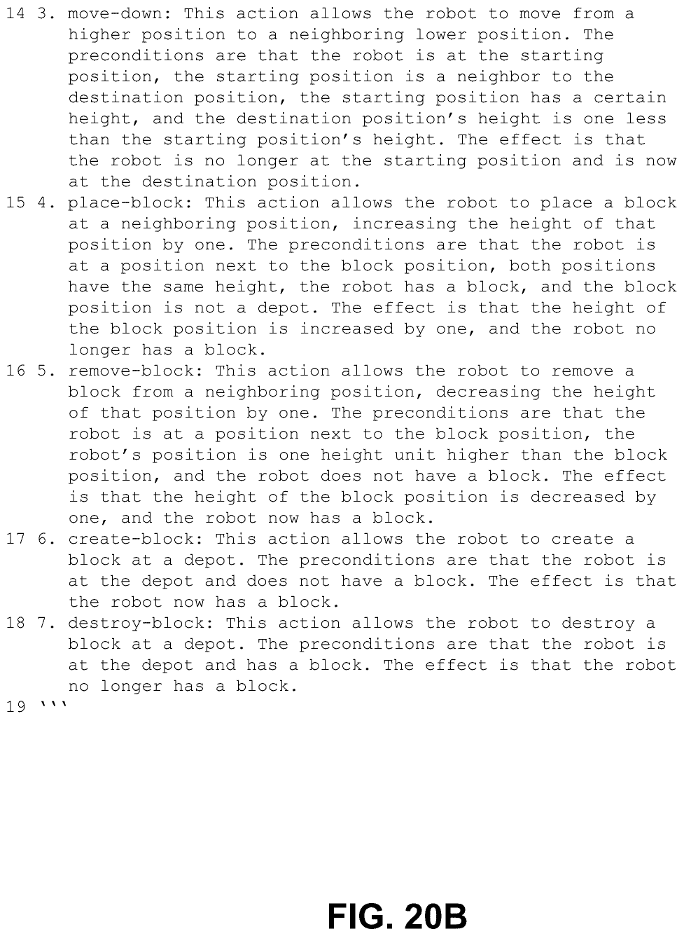

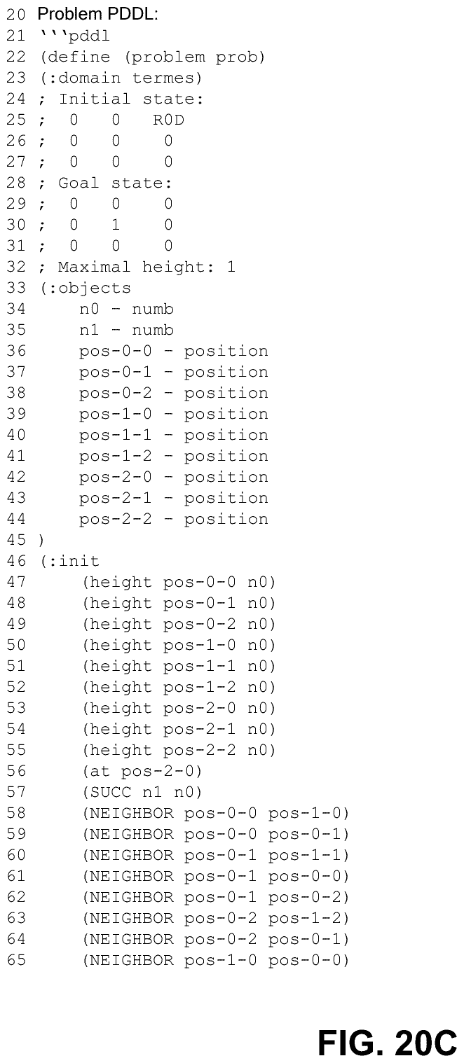

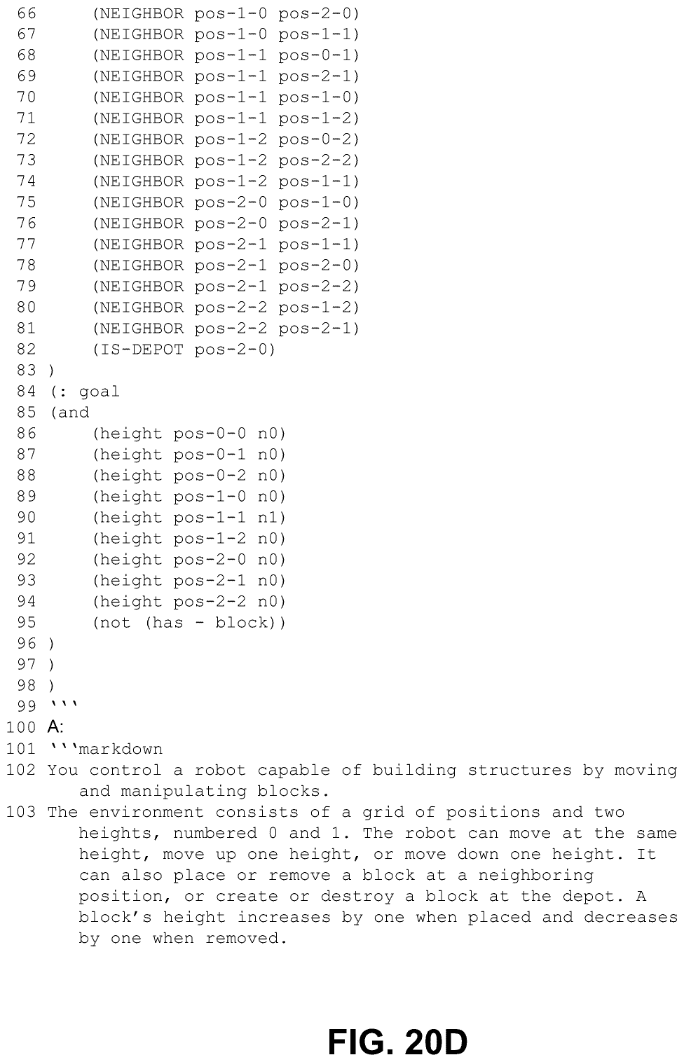

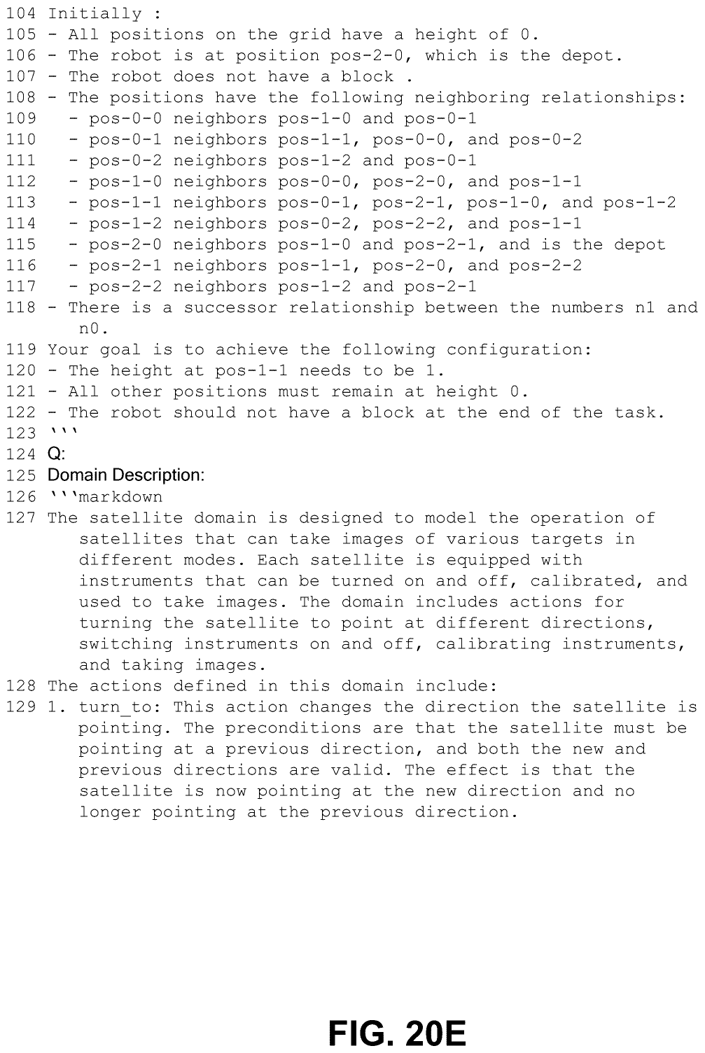

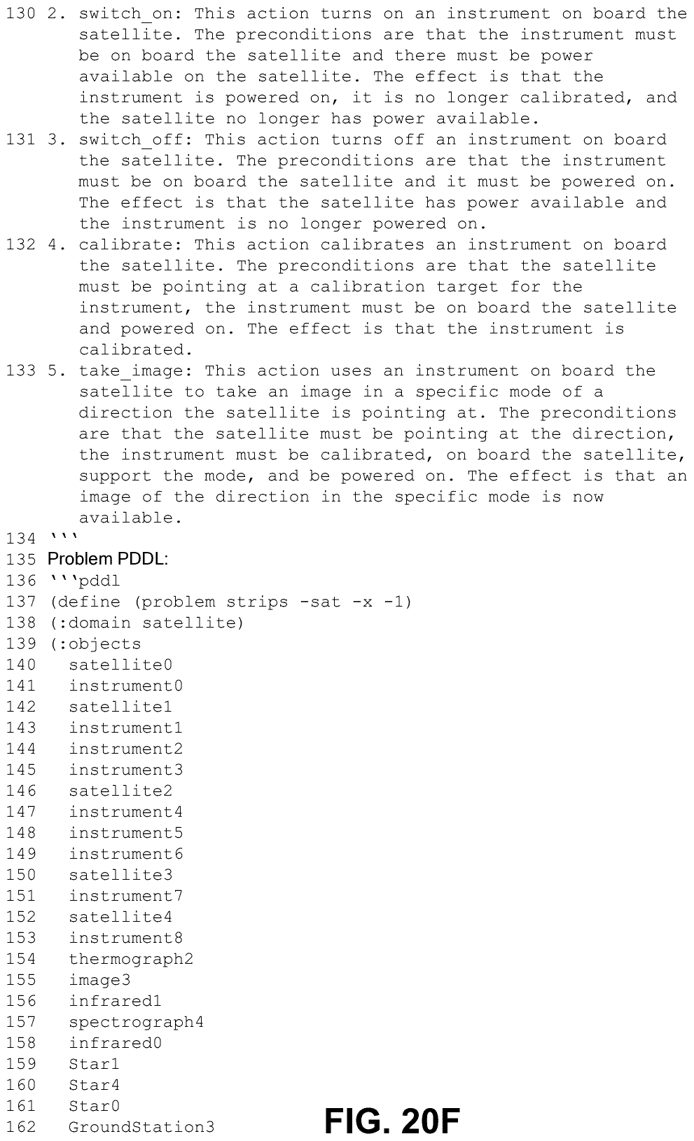

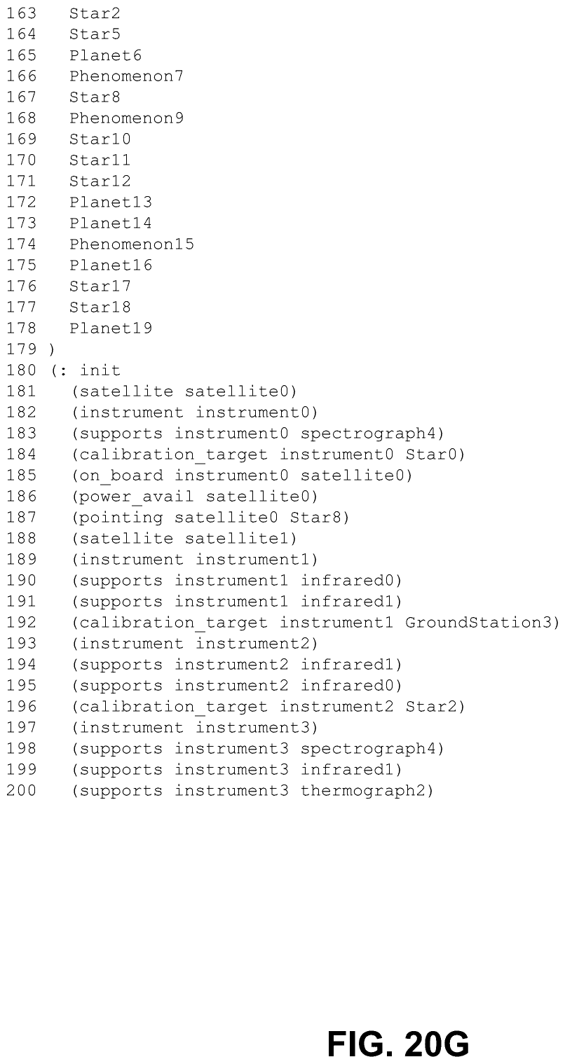

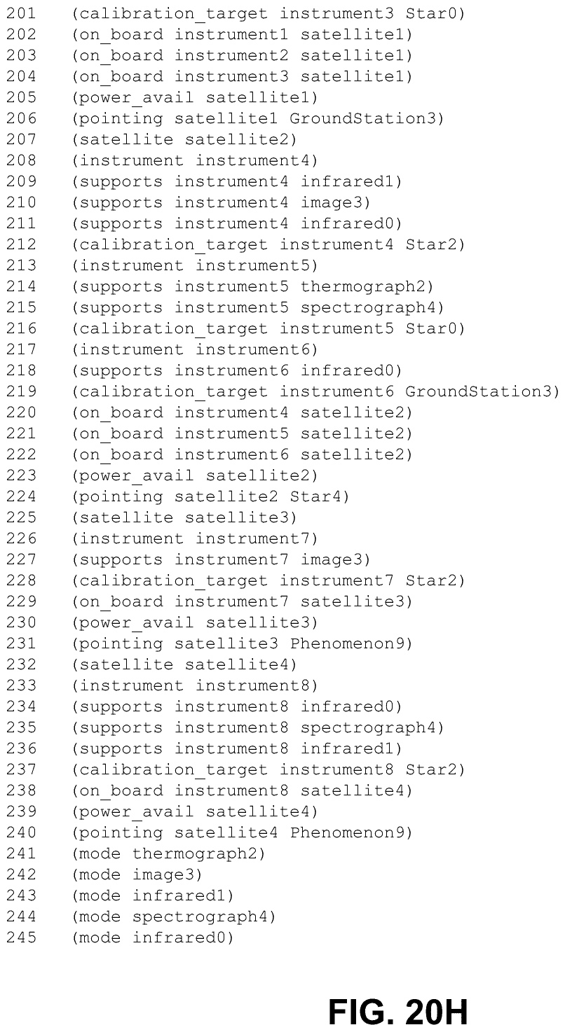

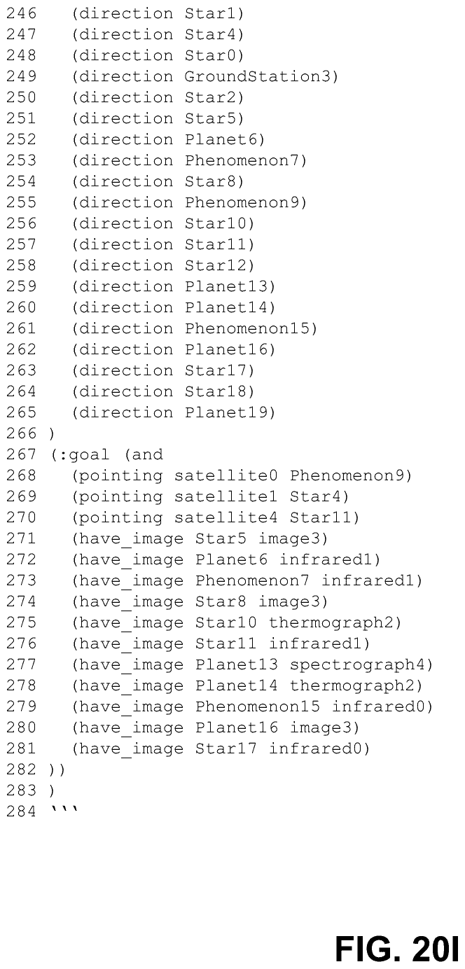

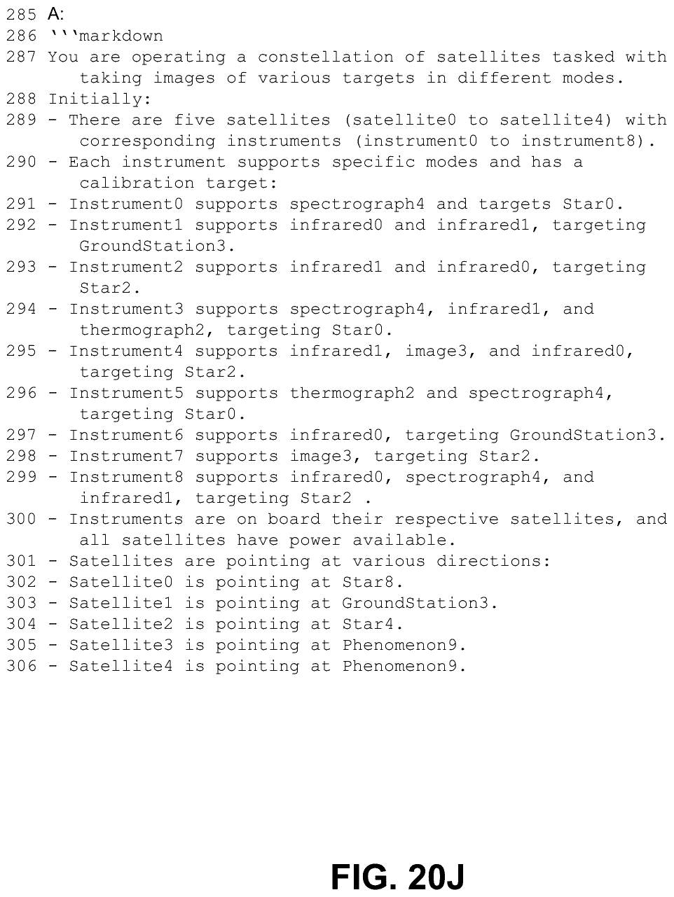

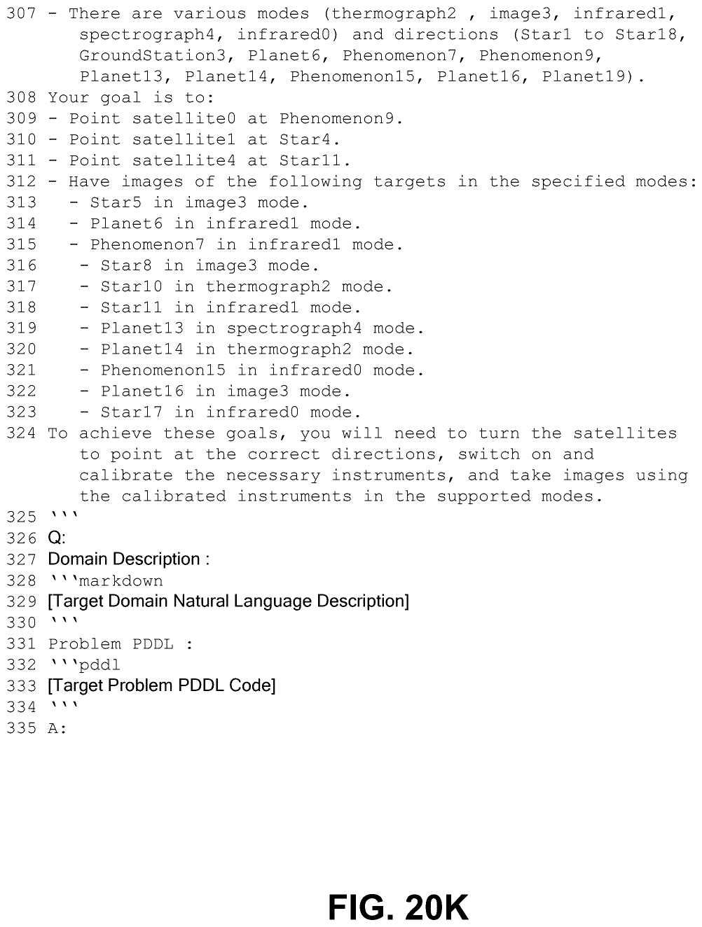

Problems: A similar few-shot translation strategy was also used for problem translation. Two diverse environments of “Termes” and “Satellite” were selected for problem two-shot problem translation. Once one problem from a target domain is translated, the problem translation can be used as in-context example to translate the rest of the problems. This step can be crucial in ensuring that all problems from the same domain are translated in a consistent manner. The example prompt is provided in FIGS. 20A to 20K, which show a domain back-translation prompt template, with domain natural language description and problem PDDL placeholders for each target domain.

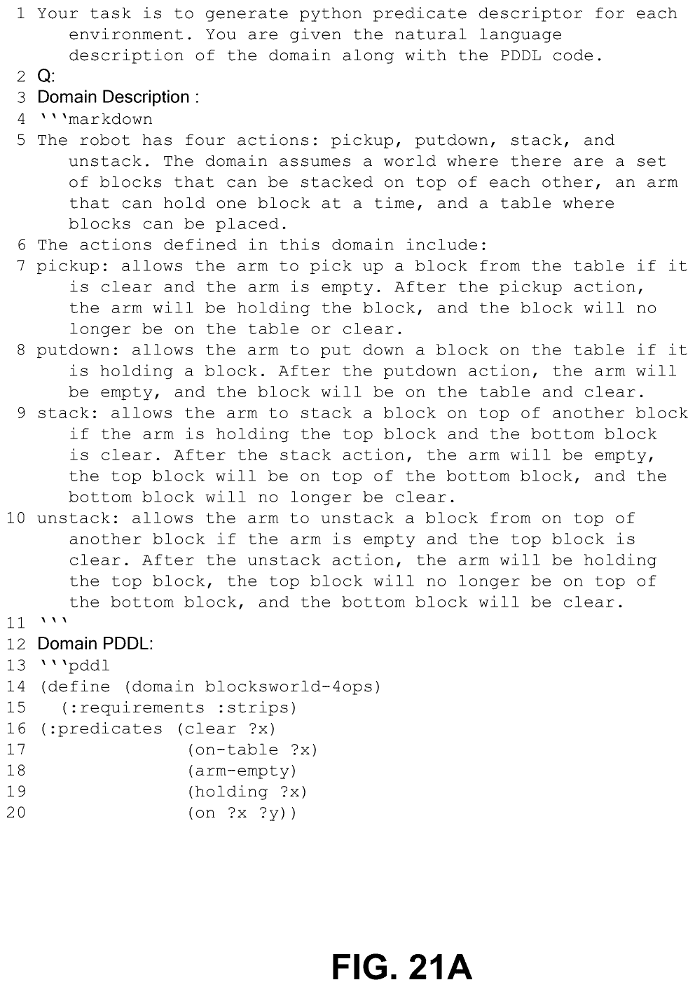

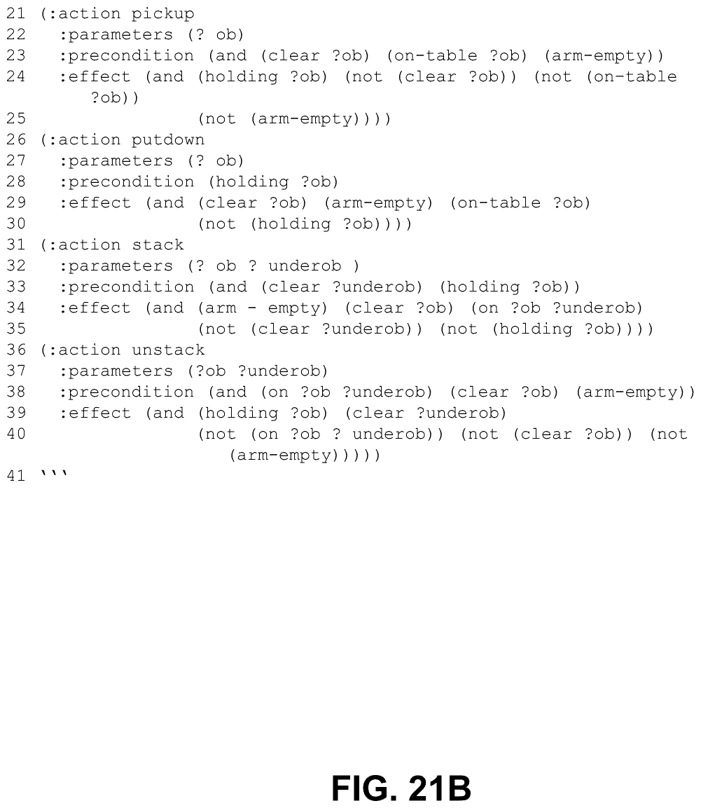

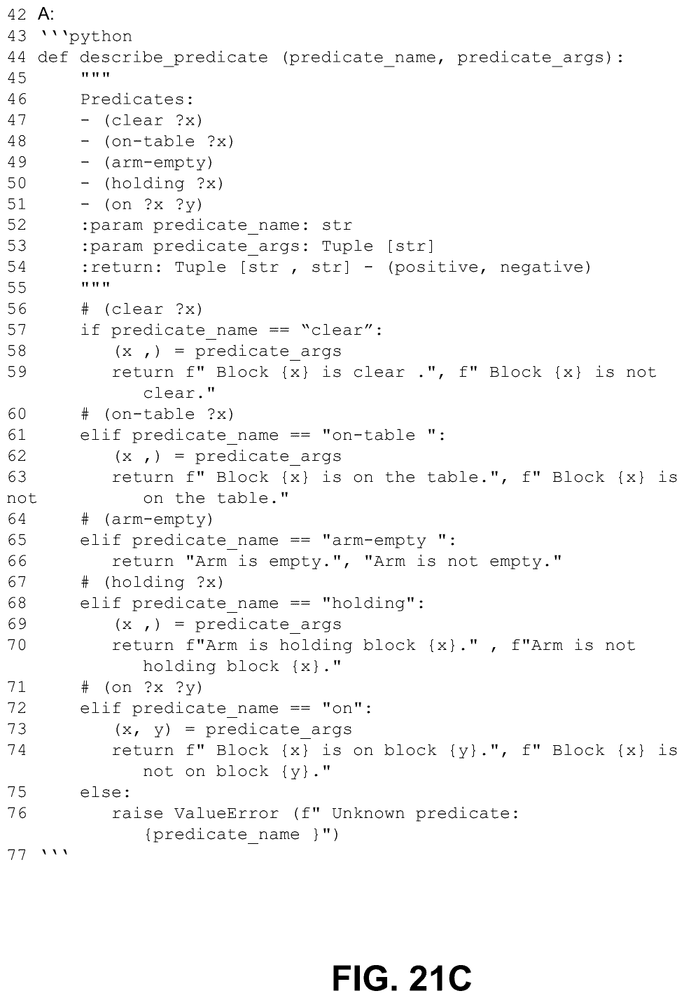

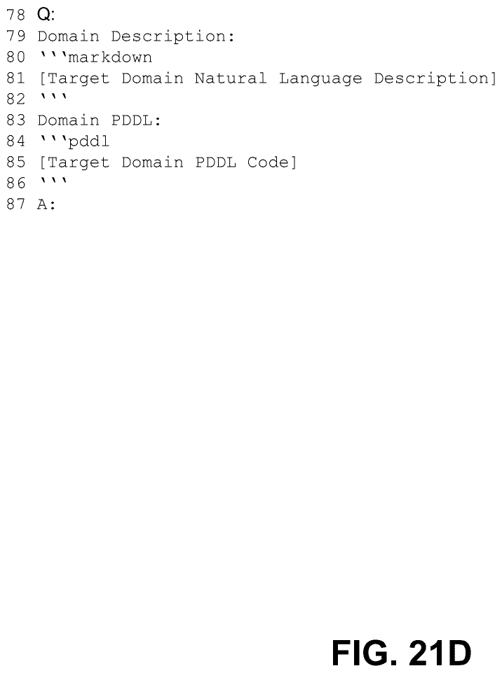

Natural Language Predicate Description: To generate natural language description of states, a Python™ file was generated for each domain, with one function to produce natural language description of predicates for state description. The example prompt is provided in FIGS. 21A to 21D, which show a predicate translation Python™ code generation prompt.

Those skilled in the art will appreciate that such various embodiments and/or features thereof may be customized and/or combined as needed or desired. Moreover, although embodiments have been described above with reference to the accompanying drawings, those of skill in the art will appreciate that variations and modifications may be made without departing from the scope thereof as defined by the appended claims.

It would be appreciated by one of ordinary skill in the art that the system and components shown in the figures may include components not shown in the drawings. For simplicity and clarity of the illustration, elements in the figures are not necessarily to scale and are only schematic. It will be apparent to persons skilled in the art that a number of variations and modifications can be made without departing from the scope of the invention as described herein.

It is contemplated that any part of any aspect or embodiment discussed in this specification can be implemented or combined with any part of any other aspect or embodiment discussed in this specification, so long as such those parts are not mutually exclusive with each other.

It should be recognized that features and aspects of the various examples provided above can be combined into further examples that also fall within the scope of the present disclosure.

When used in this specification and claims, the terms “comprises” and “comprising” and variations thereof mean that the specified features, steps or integers are included. The terms are not to be interpreted to exclude the presence of other features, steps or components. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. Further, the singular forms “a”, “an”, and “the” are intended to include the plural forms as well, unless the context clearly indicates otherwise.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

What is claimed is:

1. A method of using at least one large language model (LLM) to generate computer-readable parameters for solving a natural language planning problem using a planner, the method comprising:
obtaining a natural language description of a domain defining an environment of the planning problem, a natural language description of the planning problem defining a problem to be solved by the planning problem;
generating at least one problem candidate defining a set of problem parameters for the planning problem as at least one response from the at least one LLM in response to inputting the natural language description of the planning problem and a problem candidate template for the set of problem parameters to the at least one LLM;
for each one of the at least one problem candidate, iteratively generating a corresponding domain candidate defining a set of domain parameters for the environment by repeatedly performing an iterative loop comprising:
generating a domain candidate as a response from the at least one LLM in response to inputting the natural language description of the domain and a domain candidate template for the set of domain parameters to the at least one LLM, and any natural language feedback from a previous iteration for the domain candidate;
evaluating the domain candidate and the problem candidate; and
in response to the evaluating, obtaining the natural language feedback from the environment for use in a subsequent iteration; and
storing one of the at least one problem candidate the corresponding domain candidate based on the evaluating for execution by the planner.

2. The method of claim 1,
wherein the set of problem parameters are generated as a problem planning domain definition language (PDDL) file;
wherein the set of domain parameters are generated as a domain PDDL file;
wherein the problem candidate template is a problem PDDL template; and
wherein the domain candidate template is a domain PDDL template.

3. The method of claim 1,
wherein the set of problem parameters defines: one or more objects in the planning problem, initial conditions of the one or more objects, and goal conditions of the one or more objects; and
wherein the set of domain parameters defines: predicates of the environment and one or more actions, wherein each of the one or more actions is defined according to: one or more action parameters, one or more preconditions of the action, and one or more effects of the action.

4. The method of claim 1, wherein the iterative loop is performed a first predetermined number of times.

5. The method of claim 1,
wherein the evaluating of the domain candidate and the problem candidate comprises determining an evaluation score;
wherein the evaluation score is determined by evaluating a first metric determined by executing one or more legal actions from a set of legal actions on one or more objects in the problem candidate against a second metric determined by executing one or more actions from the domain candidate on one or more objects of a set legal objects; and
wherein the set of legal actions corresponds to the domain of problem and the set of legal objects corresponds to the problem of the planning problem.

6. The method of claim 5, wherein the first and second metric each corresponds to a percentage of valid executions.

7. The method of claim 5, wherein the evaluation score is a similarity score corresponding to a harmonic mean of the first and second metric.

8. The method of claim 5, wherein the first metric is determined by executing a second predetermined number of consecutive one or more legal actions on the one or more objects in the problem candidate and the second metric is determined by executing the second predetermined number of consecutive one or more actions on the one or more objects of the set legal objects.

9. The method of claim 5, wherein the evaluation score further comprises a negative modifier for one or more of: no possible action, invalid domain parameters, missing domain parameters, invalid domain modifications, and no domain modification.

10. The method of claim 1, further comprising, for each iteration of the first iterative loop:
generating a plurality of domain candidates,
wherein the evaluating comprises, for each one of the plurality of domain candidates:
evaluating the domain candidate and the problem candidate, and
determining, based on the evaluating, one of the plurality of domain candidates for use in the subsequent iteration.

11. The method of claim 10, wherein the plurality of domain candidates is a third predetermined number.

12. The method of claim 10,
wherein the evaluating of the domain candidate against the problem candidate comprises determining an evaluation score;
wherein the evaluation score is determined by evaluating a first metric determined by executing one or more legal actions from a set of legal actions on one or more objects in the problem candidate against a second metric determined by executing one or more actions from the domain candidate on one or more objects of a set legal objects; and
wherein the set of legal actions corresponds to the domain of problem and the set of legal objects corresponds to the problem of the planning problem.

13. The method of claim 1,
wherein the at least one problem candidate is a fourth predetermined number of a plurality of problem candidates; and
wherein a plurality of corresponding domain candidates are generated for the plurality of problem candidates.

14. The method of claim 13, further comprising: evaluating the plurality of problem candidates and the plurality of corresponding domain candidates to determine the problem candidate and the corresponding domain candidate for the storing.

15. The method of claim 14,
wherein the problem candidate and the corresponding domain candidate for the storing are determined using an evaluation score;
wherein the evaluation score is determined by evaluating a first metric determined by executing one or more legal actions from a set of legal actions on one or more objects in the problem candidate against a second metric determined by executing one or more actions from the domain candidate on one or more objects of a set legal objects; and
wherein the set of legal actions corresponds to the domain of problem and the set of legal objects corresponds to the problem of the planning problem.

16. The method of claim 1, further comprising: generating at least one domain proposal using the at least one LLM, wherein each of the at least one problem candidate is generated using one of the at least one domain proposal.

17. The method of claim 1, wherein the domain candidate is generated by using the at least one LLM to modify the domain candidate through an intermediate interface comprising predefined functions for modifying the domain candidate.

18. The method of claim 17, further comprising: solving the planning problem by inputting the problem candidate and the corresponding domain candidate for the storing to the planner to generate a sequence of actions for solving the planning problem.

19. A system comprising at least one processing unit configured to perform a method of using at least one large language model (LLM) to generate computer-readable parameters for solving a natural language planning problem using a planner, the method comprising:
obtaining a natural language description of a domain defining an environment of the planning problem, a natural language description of the planning problem defining a problem to be solved by the planning problem;
generating at least one problem candidate defining a set of problem parameters for the planning problem as at least one response from the at least one LLM in response to inputting the natural language description of the planning problem and a problem candidate template for the set of problem parameters to the at least one LLM;
for each one of the at least one problem candidate, iteratively generating a corresponding domain candidate defining a set of domain parameters for the environment by repeatedly performing an iterative loop comprising:
generating a domain candidate as a response from the at least one LLM in response to inputting the natural language description of the domain and a domain candidate template for the set of domain parameters to the at least one LLM, and any natural language feedback from a previous iteration for the domain candidate;
evaluating the domain candidate and the problem candidate; and
in response to the evaluating, obtaining the natural language feedback from the environment for use in a subsequent iteration; and
storing one of the at least one problem candidate the corresponding domain candidate based on the evaluating for execution by the planner.

20. At least one non-transitory computer readable medium having stored thereon computer-readable instructions, which, when executed by at least one processing unit, causes the at least one processing unit to perform a method of using at least one large language model (LLM) to generate computer-readable parameters for solving a natural language planning problem using a planner, the method comprising:
obtaining a natural language description of a domain defining an environment of the planning problem, a natural language description of the planning problem defining a problem to be solved by the planning problem;
generating at least one problem candidate defining a set of problem parameters for the planning problem as at least one response from the at least one LLM in response to inputting the natural language description of the planning problem and a problem candidate template for the set of problem parameters to the at least one LLM;
for each one of the at least one problem candidate, iteratively generating a corresponding domain candidate defining a set of domain parameters for the environment by repeatedly performing an iterative loop comprising:
generating a domain candidate as a response from the at least one LLM in response to inputting the natural language description of the domain and a domain candidate template for the set of domain parameters to the at least one LLM, and any natural language feedback from a previous iteration for the domain candidate;
evaluating the domain candidate and the problem candidate; and
in response to the evaluating, obtaining the natural language feedback from the environment for use in a subsequent iteration; and
storing one of the at least one problem candidate the corresponding domain candidate based on the evaluating for execution by the planner.
